(19) United States
(12) Patent Application Publication
(10) Pub. No.: US 2025/0117466 A1
(43) Pub. Date: Apr. 10, 2025

(54) AUTHENTICATION SYSTEM, AUTHENTICATION APPARATUS, AUTHENTICATION METHOD, AND NON-TRANSITORY COMPUTER-READABLE STORAGE MEDIUM

(71) Applicant: NEC Corporation, Minato-ku, Tokyo (JP)

(72) Inventor: Yoshihiro Hotta, Tokyo (JP)

(73) Assignee: NEC Corporation, Minato-ku, Tokyo (JP)

(21) Appl. No.: 18/729,573

(22) PCT Filed: Jan. 26, 2022
(86) PCT No.: PCT/JP2022/002891

§ 371 Date: Jul. 17, 2024

(51) Int. Cl. G06F 21/32; G06V 40/16

(52) U.S. Cl. CPC G06F 21/32; G06V 40/172

(57) ABSTRACT

An authentication apparatus (100) includes: an acquisition unit (102) that acquires a facial image of a target person being a person to be a target of authentication; a display processing unit (104) that performs first processing of causing a screen that can be looked at by the target person to display a question and also causing the screen to display direction information indicating a direction to be looked at by the target person when the target person answers the question; a determination unit (106) that performs second processing of determining a direction being looked at by the target person by using the facial image; and an authentication unit (108) that performs third processing of, by using a direction to be looked at by the target person when the target person answers the question and a direction determined to be looked at by the target person, authenticating the person.

### TECHNICAL FIELD

The present invention relates to an authentication system, an authentication apparatus, an authentication method, and a program.

### BACKGROUND ART

A system performing an examination by using a remote terminal is becoming widespread in recent years; but on the other hand, an issue of a person improperly taking an examination by a spoofing act by a proxy is occurring.

Patent Document 1 describes an example of an authentication apparatus that prevents improper use by distinguishing an actual object from a photograph or a model at authentication of an authentication target object such as a face. The authentication apparatus in Patent Document 1 includes: an authentication signal generator that generates a guiding signal for directing the same authentication target person in at least two different directions; a static face feature extraction engine that extracts a feature value for determining the authentication target person from each piece of facial image information of the authentication target person facing in various directions guided by the generated signal; and an authentication unit that decides whether the authentication target person is a registered person, based on a result of comparing the plurality of extracted feature values with a plurality of feature values for determining a preregistered person. In other words, the authentication apparatus can detect an improper act by extracting and registering multifaceted feature values of a face acquired by directing an authentication target person in predetermined directions and checking the feature values against feature values of a face acquired by randomly directing the authentication target person in the same directions at authentication; however, there is an issue that registration of feature values of a face is time-consuming.

Patent Document 2 describes an authentication apparatus including a mechanism for enhancing reliability of a challenge-response test for confirming that a user of an online service is a human rather than a computer program (a so-called bot). The authentication apparatus in Patent Document 2 transmits instructions about gestures different from each other to an output unit in a plurality of sequentially performed challenges, decides, in each of the plurality of challenges, whether a response time related to a response to the challenge is within a predetermined time, and confirms existence of a user, based on the response.

### RELATED DOCUMENTS

### Patent Documents

Patent Document 1: Japanese Patent Application Publication No. 2007-122400
Patent Document 2: Japanese Patent Application Publication No. 2020-140721

### SUMMARY OF INVENTION

### Technical Problem

The aforementioned authentication apparatus described in Patent Document 2 outputs an instruction for causing a predetermined action to be performed to an authentication target person, verifies an action responding to the instruction, and confirms actual existence of a user, based on the response time; and therefore, there is an issue that the apparatus can confirm that the authentication target person is a human rather than a bot but cannot confirm whether the authentication target person is the actually existing person himself or herself.

An example of an object of the present invention is to, in view of the aforementioned issues, provide an authentication system, an authentication apparatus, an authentication method, and a program that can resolve the issue that whether a person being an authentication target is the actually existing person himself or herself cannot be confirmed.

### Solution to Problem

An aspect of the present invention provides an authentication apparatus including:
an acquisition unit that acquires a facial image of a target person being a person to be a target of authentication;
a display processing unit that performs first processing of causing a screen that can be looked at by the target person to display a question and also causing the screen to display direction information indicating a direction to be looked at by the target person when the target person answers the question;
a determination unit that performs second processing of determining a direction being looked at by the target person by using the facial image; and
an authentication unit that performs third processing of, by using a direction to be looked at by the target person when the target person answers the question and a direction determined to be looked at by the target person, authenticating the person.

An aspect of the present invention provides an authentication system including:
an information processing apparatus; and
an authentication apparatus connected to the information processing apparatus through a network, wherein
the information processing apparatus includes:
   a display unit that displays a screen that can be looked at by a person to be a target of authentication; and
   an image capture unit that generates a facial image of the person looking at the screen, and
the authentication apparatus includes:
   an acquisition unit that acquires a facial image of a target person being a person to be a target of authentication;
   a display processing unit that performs first processing of causing a screen that can be looked at by the target person to display a question and also causing the screen to display direction information indicating a direction to be looked at by the target person when the target person answers the question;
   a determination unit that performs second processing of determining a direction being looked at by the target person by using the facial image; and
   an authentication unit that performs third processing of, by using a direction to be looked at by the target person when the target person answers the question and a direction determined to be looked at by the target person, authenticating the person.

An aspect of the present invention provides an authentication method including, by one or more computers:
acquiring a facial image of a target person being a person to be a target of authentication;
performing first processing of causing a screen that can be looked at by the target person to display a question and also causing the screen to display direction information indicating a direction to be looked at by the target person when the target person answers the question;
performing second processing of determining a direction being looked at by the target person by using the facial image; and
performing third processing of, by using a direction to be looked at by the target person when the target person answers the question and a direction determined to be looked at by the target person, authenticating the person.

An aspect of the present invention provides a program for causing one or more computers to execute:
a procedure for acquiring a facial image of a target person being a person to be a target of authentication;
a procedure for performing first processing of causing a screen that can be looked at by the target person to display a question and also causing the screen to display direction information indicating a direction to be looked at by the target person when the target person answers the question;
a procedure for performing second processing of determining a direction being looked at by the target person by using the facial image; and
a procedure for performing third processing of, by using a direction to be looked at by the target person when the target person answers the question and a direction determined to be looked at by the target person, authenticating the person.

Note that the present invention may include a storage medium readable by a computer on which the program according to the aspect of the present invention is recorded. The storage medium includes a non-transitory tangible medium.

The computer program includes a computer program code causing a computer to execute the authentication method on an authentication apparatus when being executed by the computer.

Note that any combination of the components described above, and representations of the present invention converted between a method, an apparatus, a system, a storage medium, a computer program, and the like are also valid as embodiments of the present invention.

Further, various components of the present invention do not necessarily need to be individually independent, and for example, a plurality of components may be formed as a single member, a plurality of members may form a single component, a certain component may be part of another component, and part of a certain component may overlap with part of another component.

Further, while a plurality of procedures are described in a sequential order in the method and the computer program according to the present invention, the order of description does not limit the order of execution of the plurality of procedures. Therefore, when the method and the computer program according to the present invention are executed, the order of the plurality of procedures may be changed without affecting the contents.

Furthermore, a plurality of procedures in the method and the computer program according to the present invention are not limited to be executed at timings different from each other. Therefore, for example, a certain procedure may be generated during execution of another procedure, and an execution timing of a certain procedure and an execution timing of another procedure may overlap with each other in part or in whole.

### Advantageous Effects of Invention

The aspect of the present invention enables resolution to the issue of inability to confirm whether a person being an authentication target is the actually existing person himself or herself.

### BRIEF DESCRIPTION OF THE DRAWINGS

FIG. 1 It is a diagram illustrating an overview of an authentication apparatus according to an example embodiment.

FIG. 2 It is a flowchart illustrating an example of the operation of the authentication apparatus in FIG. 1.

FIG. 3 It is a diagram conceptually illustrating a system configuration of an authentication system according to an example embodiment.

FIG. 4 It is a diagram illustrating a data structure example of user registration information.

FIG. 5 It is a diagram illustrating examples of a screen displayed by a display processing unit.

FIG. 6 It is a block diagram illustrating a hardware configuration of a computer providing the authentication apparatus illustrated in FIG. 1.

FIG. 7 It is a diagram for illustrating an example of a method for determining a line-of-sight direction by a determination unit.

FIG. 8 It is a flowchart illustrating a detailed operation example of authentication processing in FIG. 2.

FIG. 9 It is a diagram illustrating data structure examples of question information.

FIG. 10 It illustrates an example of question information in which standard answers for an authentication target person are stored.

FIG. 11 It is a flowchart illustrating an example of the operation of an authentication apparatus according to an example embodiment.

FIG. 12 It is a diagram illustrating an example of a screen displayed in Step S203.

FIG. 13 It is a diagram illustrating a flowchart illustrating an example of first determination processing in FIG. 11.

FIG. 14 It is a diagram illustrating a flowchart illustrating an example of second determination processing in FIG. 11.

FIG. 15 It is a functional block diagram illustrating a functional configuration example of an authentication apparatus according to an example embodiment.

FIG. 16 It is a diagram illustrating an example of a registration screen.

FIG. 17 It is a diagram illustrating an example of a plurality of predetermined questions.

FIG. 18 It is a diagram illustrating examples of a plurality of alternatives to a question.

FIG. 19 It is a flowchart illustrating an example of the operation of an authentication apparatus according to an example embodiment.

FIG. 20 It is a diagram illustrating an example of a screen displayed by a display processing unit.

FIG. 21 It is a flowchart illustrating an example of the operation of an authentication apparatus according to an example embodiment.

FIG. 22 It is a functional block diagram illustrating a functional configuration example of an authentication apparatus according to an example embodiment.

FIG. 23 It is a flowchart illustrating an example of detecting a predetermined wearing article in a method for processing improper act detection in authentication processing in FIG. 21.

FIG. 24 It is a flowchart illustrating an example of not being able to acquire a face in the method for processing improper act detection in the authentication processing in FIG. 21.

FIG. 25 It is a flowchart illustrating an example of detecting a change in a background in the method for processing improper act detection by a detection unit 112 in the authentication processing in FIG. 21.

### EXAMPLE EMBODIMENT

Example embodiments of the present invention will be described below by using drawings. Note that in every drawing, similar components are given similar signs, and description thereof is not included as appropriate. Further, in each of the following diagrams, a configuration of a part not related to the essence of the present invention is not included and is not illustrated.

In the example embodiments, “acquisition” includes at least one item out of an apparatus getting data or information stored in another apparatus or storage medium (active acquisition), and an apparatus inputting data or information output from another apparatus to the apparatus (passive acquisition). Examples of the active acquisition include making a request or an inquiry to another apparatus and receiving a response, and readout by accessing another apparatus or storage medium. Further, examples of the passive acquisition include reception of distributed (or, for example, transmitted or push notified) information. Furthermore, “acquisition” may refer to selective acquisition from received data or information, or selective reception of distributed data or information.

### Minimum Configuration Example

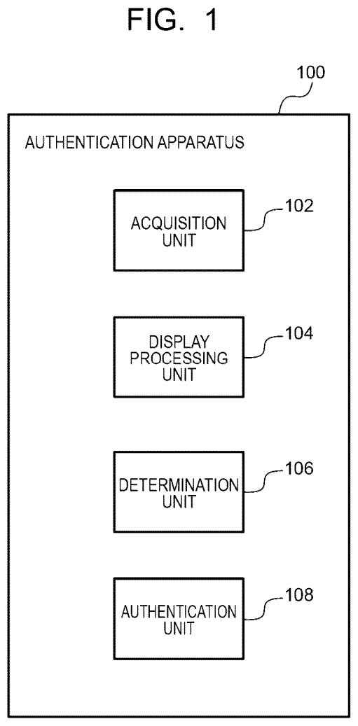

FIG. 1 is a diagram illustrating an overview of an authentication apparatus 100 according to an example embodiment. The authentication apparatus 100 includes an acquisition unit 102, a display processing unit 104, a determination unit 106, and an authentication unit 108.

The acquisition unit 102 acquires a facial image of a target person being a person to be a target of authentication.

The display processing unit 104 performs first processing of causing a screen that can be looked at by a target person to display a question and also causing the screen to display direction information indicating a direction to be looked at by the target person when the target person answers the question.

The determination unit 106 performs second processing of determining a direction being looked at by a target person by using a facial image.

The authentication unit 108 performs third processing of, by using a direction to be looked at by a target person when the target person answers a question and a direction determined to be looked at by the target person, authenticating the person.

For example, as a service used by a person, when an examination or the like is remotely performed by using an operation terminal, the authentication apparatus 100 can confirm that the person himself or herself actually exists at the location and is taking the examination.

### Operation Example

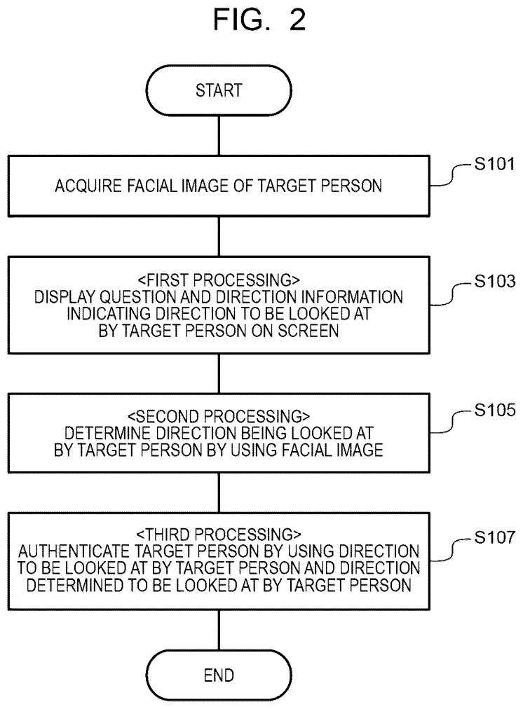

FIG. 2 is a flowchart illustrating an example of the operation of the authentication apparatus 100 in FIG. 1.

First, the acquisition unit 102 acquires a facial image of a target person (Step S101). Then, as the first processing, the display processing unit 104 causes the screen to display a question and also causes the screen to display direction information indicating a direction to be looked at by the target person when the target person answers the question (Step S103).

As the second processing, the determination unit 106 determines a direction being looked at by the target person (hereinafter also referred to as a line-of-sight direction) by using the facial image acquired by the acquisition unit 102 (Step S105). Then, as the third processing, by using the direction to be looked at by the target person when the target person answers the question (the left side of a screen 200 in this case) and the line-of-sight direction determined to be looked at by the target person by the determination unit 106, the authentication unit 108 authenticates the target person (Step S107).

As described above, the authentication apparatus 100 can perform authentication processing by causing, by the display processing unit 104, the screen 200 being looked at by a person being an authentication target to display a question and direction information indicating a direction to be looked at when the target person answers the question, acquiring, by the acquisition unit 102, a facial image of the person looking at the screen 200, determining, by the determination unit 106, the line of sight of the person, and determining, by the authentication unit 108, that the person being the authentication target actually exists in front of the screen 200 by using the direction and the line-of-sight direction and therefore provides an effect of enabling resolution to the issue of inability to confirm that a person being an authentication target is the actually existing person himself or herself.

Detailed examples of the authentication apparatus 100 will be described below.

### First Example Embodiment

### <System Overview>

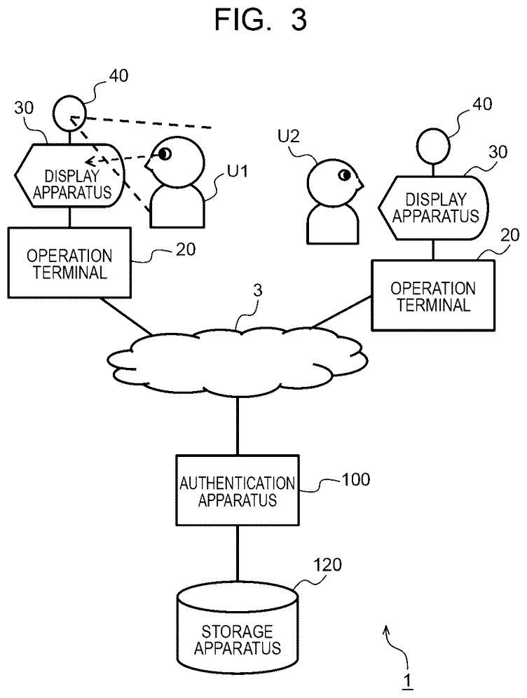

FIG. 3 is a diagram conceptually illustrating a system configuration of an authentication system 1 according to an example embodiment.

The authentication system 1 includes an authentication apparatus 100 and at least one operation terminal 20 connected to the authentication apparatus 100 through a communication network 3. The authentication apparatus 100 includes a storage apparatus 120. The storage apparatus 120 may be provided inside the authentication apparatus 100 or outside the authentication apparatus 100. In other words, the storage apparatus 120 may be hardware integrated with the authentication apparatus 100 or hardware separate from the authentication apparatus 100.

The operation terminal 20 includes a display apparatus 30 and a camera 40. For example, the operation terminal 20 is a terminal operated by each of operators U1 and U2 (hereinafter referred to as operators U) and is a computer such as a personal computer, a smartphone, or a tablet terminal.

Examples of a conceivable method of using a service include installing and starting a predetermined application and accessing a predetermined website by using a browser or the like. In order to use a predetermined service, an operator U previously user-registers authentication information used for personal confirmation as account information. Then, when the operator U logs in by using the authentication information at service use and the authentication is successful, use of the service is enabled. Furthermore, while details will be described in an example embodiment to be described later, the authentication apparatus 100 performs authentication processing during service use as well.

According to the present example embodiment, the authentication processing is performed by using biometric information of a target person as authentication information. For example, biometric information is at least one of a feature value of the face, an iris, and a pinna.

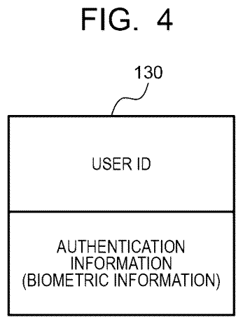

FIG. 4 is a diagram illustrating a data structure example of user registration information 130. The user registration information 130 associates user identification information (hereinafter also referred to as a user ID) assigned to an operator U with authentication information and is stored in the storage apparatus 120. While biometric information is used as authentication information in the example embodiment as described above, the authentication information may be combined with a password, a PIN, or the like.

The authentication apparatus 100 extracts a feature value of a face from a facial image acquired by capturing an image of the face of an authentication target person in front of an operation terminal 20 by the camera 40 in the operation terminal 20 and checks the feature value against preregistered biometric information (a feature value of the face). For example, the authentication apparatus 100 determines that authentication is successful when a degree of matching between the feature value of the face extracted from the facial image and the registered feature value of the face is equal to or greater than a threshold value and determines that the authentication is a failure when the degree of matching is less than the threshold value.

For example, the display apparatus 30 is a liquid crystal display or an organic electro-luminescence (EL) display. When the operation terminal 20 is a smartphone or a tablet terminal, the display apparatus 30 may be a touch panel in which a display unit and an operation acceptance unit are integrated.

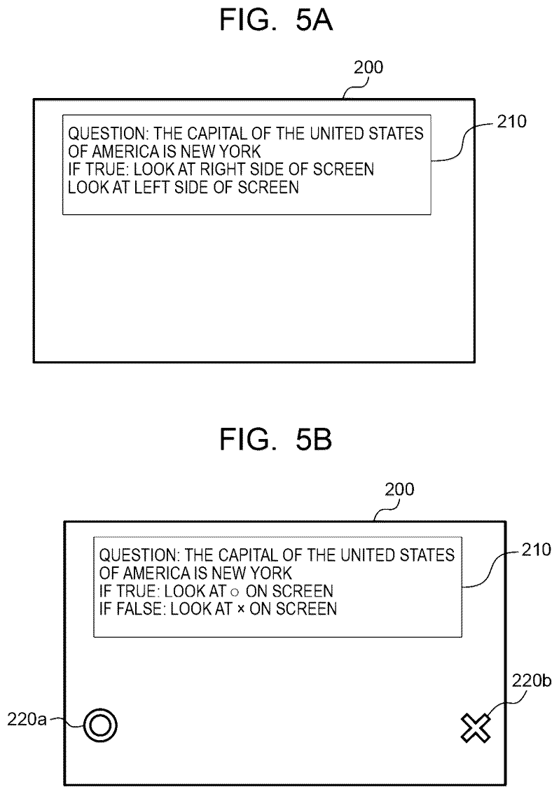

The display apparatus 30 displays a screen that can be looked at by an operator U. FIG. 5 is a diagram illustrating examples of a screen 200 displayed by the display processing unit 104. In an example in FIG. 5(a), the screen 200 includes a message display part 210 displaying a message indicating a question asking whether the capital of the United States of America is New York. Then, direction information indicating a direction to be looked at when the target person answers the question (the right side for true, and the left side for false) is also included together in the message displayed in the message display part 210 in this example.

In an example in FIG. 5(b), the screen 200 includes mark display parts 220 as direction information indicating directions at which a person should look when the person answers the question in addition to the message display part 210 displaying the message indicating the question asking whether the capital of the United States of America is New York. A mark display part 220a being “o (circle)” indicating true is displayed on the left side of the screen 200, and a mark display part 220b being “x (cross mark)” indicating false is displayed on the right side of the screen 200.

The screen 200 is displayed on the display apparatus 30 in the operation terminal 20 with which an operator U uses a service. For example, the screen 200 may be displayed on the display apparatus 30 in the operation terminal 20 before or after the authentication processing at a login before service use or may be displayed on the display apparatus 30 by displaying a separate window including the message display part 210 by superimposition on a screen for a service in use. Specific examples of a display timing of the screen 200 will be described in detail in an example embodiment to be described later.

The camera 40 includes a lens and an image pickup device such as a charge coupled device (CCD) image sensor. While the camera 40 is hardware integrated with the operation terminal 20 in the example in FIG. 3, the camera 40 may be hardware separate from the operation terminal 20 in another example. However, the camera 40 is preferably hardware integrated with the display apparatus 30 in order to securely capture an image of a person looking at the screen 200 displayed by the display processing unit 104 in the authentication apparatus 100. For example, the operation terminal 20 is a notebook-type personal computer, and the camera 40 is preferably provided in the upper part of display apparatus 30 in the operation terminal 20 on the display side. Alternatively, the operation terminal 20 is a smartphone or a tablet terminal, and the camera 40 is preferably provided at an edge on the side of a touch panel being the display apparatus 30 in the operation terminal 20.

In other words, the camera 40 is provided at a position allowing image capture of the face of an operator U looking at the screen 200 displayed on a display of the display apparatus 30 in the operation terminal 20 when the operator U looks at the screen 200. The camera 40 may have a function of following movement of a person being an image capture target and performing direction control of the camera body and/or the lens, zoom control, focusing, and the like.

Images generated by the camera 40 are preferably generated by real-time image capture. Note that images generated by the camera 40 may be images delayed by a predetermined time. Images captured by the camera 40 may be temporarily stored into a storage apparatus (a memory 1030 or a storage device 1040) in another operation terminal 20 and be read from the storage apparatus sequentially or at predetermined intervals by the authentication apparatus 100. Furthermore, images acquired by the authentication apparatus 100 may be dynamic images, frame images generated at predetermined intervals, or static images.

### Hardware Configuration Example

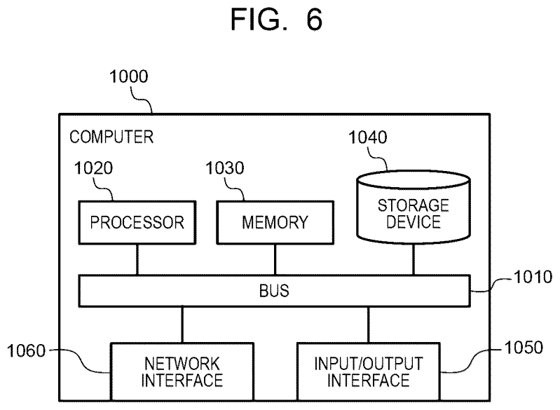

FIG. 6 is a block diagram illustrating a hardware configuration of a computer 1000 providing the authentication apparatus 100 illustrated in FIG. 1. Each operation terminal 20 in the authentication system 1 in FIG. 3 is also provided by the computer 1000.

The computer 1000 includes a bus 1010, a processor 1020, a memory 1030, a storage device 1040, an input-output interface 1050, and a network interface 1060.

The bus 1010 is a data transmission channel for the processor 1020, the memory 1030, the storage device 1040, the input-output interface 1050, and the network interface 1060 to transmit and receive data to and from each other. Note that the method for interconnecting the processor 1020 and other components is not limited to a bus connection.

The processor 1020 is a processor provided by a central processing unit (CPU), a graphics processing unit (GPU), or the like.

The memory 1030 is a main storage provided by a random-access memory (RAM) or the like.

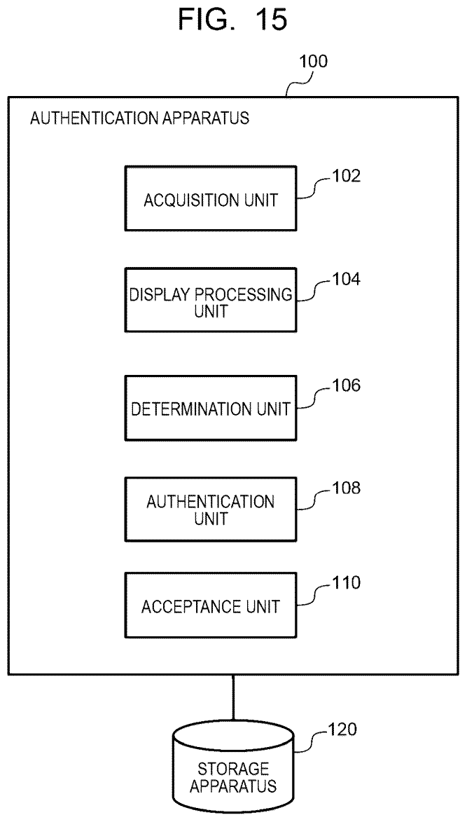

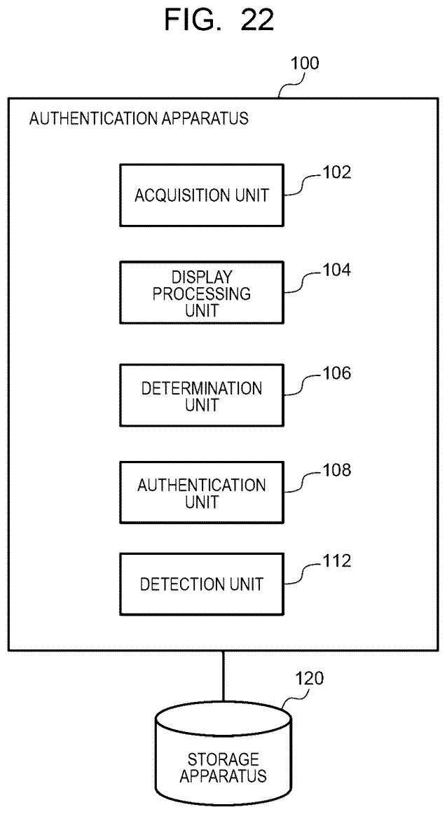

The storage device 1040 is an auxiliary storage provided by a hard disk drive (HDD), a solid-state drive (SSD), a memory card, a read-only memory (ROM), or the like. The storage device 1040 stores program modules for providing the functions of the authentication apparatus 100 (such as the acquisition unit 102, the display processing unit 104, the determination unit 106, and the authentication unit 108 in FIG. 1, and an acceptance unit 110 in FIG. 15 and a detection unit 112 in FIG. 22 to be described later). By reading each program module into the memory 1030 and executing the program module by the processor 1020, each function related to the program module is provided. Further, the storage device 1040 also functions as the storage apparatus 120 storing various types of information used by the authentication apparatus 100. Further, the storage device 1040 may also function as a storage apparatus (unillustrated) storing various types of information used by the operation terminal 20.

Each program module may be recorded on a storage medium. The storage medium on which the program module is recorded includes a non-transitory tangible medium usable to the computer 1000, and a program code readable by the computer 1000 (the processor 1020) may be embedded in the medium.

The input-output interface 1050 is an interface for connecting the computer 1000 to various types of input/output equipment.

The network interface 1060 is an interface for connecting the computer 1000 to the communication network 3. Examples of the communication network 3 include a local area network (LAN) and a wide area network (WAN). The method for connecting the network interface 1060 to the communication network 3 may be a wireless connection or a wired connection. Note that the network interface 1060 may not be used.

Then, the computer 1000 is connected to required equipment [such as the display device 30, the camera 40, and an operation unit (unillustrated) in the operation terminal 20] through the input-output interface 1050 or the network interface 1060.

The authentication system 1 may be provided by a plurality of computers 1000 constituting the authentication apparatus 100.

The example of the authentication system 1 in FIG. 3 illustrates a so-called client-server system configuration. The authentication apparatus 100 functions as a server connected to each operation terminal 20 through the communication network 3, and the operation terminal 20 functions as a client terminal. Note that a configuration in which the function of the authentication apparatus 100 is provided by accessing a server on a cloud from the operation terminal 20 through the Internet [such as software as a service (Saas), platform as a service (PaaS), or hardware/infrastructure as a service (HaaS/IaaS)] may be employed.

Further, a stand-alone system may be employed in another example. The function of the authentication apparatus 100 may be provided by installing a program providing the function of the authentication apparatus 100 on each operation terminal 20 and starting the program on the operation terminal 20.

Each component in the authentication apparatuses 100 according to example embodiments in FIG. 1, and FIG. 15 and in FIG. 22 to be described later is provided by any combination of hardware and software of the computer 1000 in FIG. 6. Then, it is understood by a person skilled in the art that various modifications to the providing method and the apparatus can be made. A functional block diagram illustrating the authentication apparatus 100 according to each example embodiment represents logical function-based blocks rather than a hardware-based configuration.

### Functional Configuration Example

A functional configuration example of the authentication apparatus 100 will be described in detail below by using FIG. 1.

The acquisition unit 102 acquires a facial image of a person being in front of the operation terminal 20 and looking at the screen 200 (an operator U), the facial image being generated by capturing an image of the operator U by the camera 40 in the operation terminal 20. The facial image acquired by the acquisition unit 102 is used for second processing of determining the line-of-sight direction of the operator U by the determination unit 106 and third processing of authenticating the operator U by the authentication unit 108. In other words, the acquisition unit 102 acquires a facial image of the operator U on each occasion of execution of the second processing by the determination unit 106 and execution of the third processing by the authentication unit 108.

As first processing, the display processing unit 104 causes the screen 200 of the display apparatus 30 in the operation terminal 20 to display a question and also causes the screen 200 to display direction information indicating a direction to be looked at by a target person when the target person answers the question. By looking at the question and the direction information indicating the direction at which a target person should look when the target person answers the question, the operator U can turn the line of sight to the direction.

Various conceivable examples of a “question” include the following but are not limited thereto. Note that details will be described in an example embodiment to be described later.

(1) A question asking true or false that can be answered by anyone
An example of a question: The capital of Japan is Tokyo; o or x?
An example of a direction to be looked at: toward the upper part of the screen for o (true) and toward the lower part for x (false)
An example of a direction to be looked at: a o mark on the screen for o (true) and a x mark for x (false)
   (2) A question asking whether a countersign preregistered by a target person is true or false
An example of a question: You are from Tokyo; O or x?
An example of a direction to be looked at: the same as (1)
   (3) A question asking the position of a displayed object
An example of a question: Look at a position where an icon of a dog is displayed.
An example of a direction to be looked at: the display position of an icon of a dog
   (4) A question asking a countersign preregistered by a target person
An example of a question: Where are you from?
An example of a direction to be looked at: a direction indicating the correct answer out of toward the right part of the screen for Tokyo, toward the left part for Osaka, toward the upper part for Hokkaido, and toward the lower part for Okinawa
An example of a direction to be looked at: an icon display position indicating the correct answer out of “Tokyo,” “Osaka,” “Hokkaido,” and “Okinawa”

A question and direction information indicating a direction to be looked at by a target person when the target person answers the question are stored in the storage apparatus 120 in association with each other. Direction information is represented by a position or a region indicated by coordinates on the screen 200. The display processing unit 104 displays a question and report information with reference to the storage apparatus 120. Further, the determination unit 106 also acquires direction information related to the screen 200 displayed by the display processing unit 104, that is, a direction to be looked at by a person.

For example, the display processing unit 104 displays a question and direction information indicating a direction to be looked at by a target person on the screen 200 that can be looked at by the target person with a random change on each occasion. For example, a question selected from among a plurality of questions may be displayed. Alternatively, a direction to be looked at by a target person when the target person answers a question may be changed. For example, the display positions of the mark display part 220a (o) indicating a correct answer and the mark display part 220b (x) indicating an incorrect answer may be changed on each occasion in the example in FIG. 5(b).

As the second processing, the determination unit 106 determines a direction being looked at by a target person (a line-of-sight direction) by using a facial image of the target person acquired by the acquisition unit 102. A line-of-sight direction is indicated by position information, such as coordinate information, on the screen 200.

As the third processing, by using a direction to be looked at by a target person when the target person answers a question and a direction determined to be looked at by the target person (a line-of-sight direction), the authentication unit 108 performs processing of authenticating the person.

Specifically, for example, the authentication unit 108 decides whether a direction being looked at by a target person (a line-of-sight direction) determined by the determination unit 106 is included in a region related to a direction to be looked at by the target person when the target person answers a question. Alternatively, whether a value (a distance) indicating the displacement between a position indicating the direction to be looked at by the target person and the position of the line-of-sight direction is equal to or less than a threshold value may be decided. The latter example will be described in a second example embodiment to be described later. An existing technology may be used as the method for detecting the line-of-sight direction by image processing.

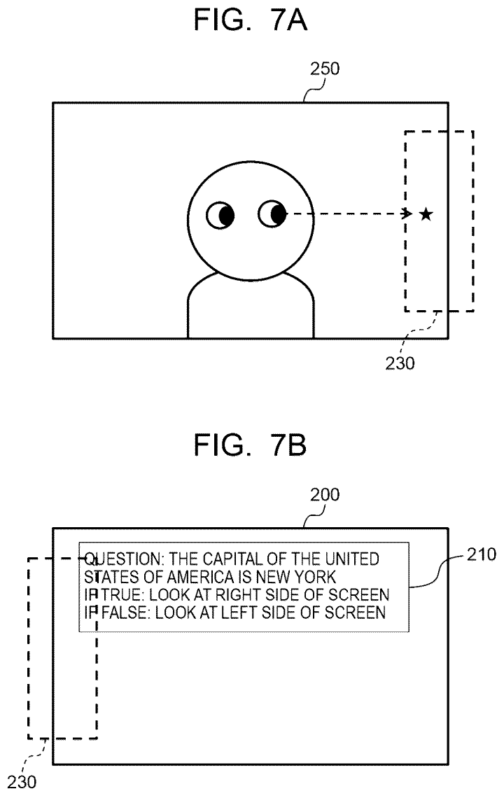

FIG. 7(a) illustrates a facial image 250 of an operator U turning the line of sight in a direction to be looked at by a target person when the target person answers a question. The determination unit 106 determines the line-of-sight direction of a person (a position indicated by ★ (a star mark) in the diagram) by performing image processing on the facial image 250 of the operator U. The authentication unit 108 decides whether the determined line-of-sight direction is within the limits of a region 230 on the left side of the screen 200 including a direction to be looked at for the answer (the capital of the United States of America is not New York) to a question on the screen 200 in FIG. 7(b).

For example, the region 230 including a direction to be looked at by a person may be set in such a way as to include a region separated by a predetermined distance around a coordinate position indicating direction information. For example, the distance in the X-axis direction may differ from the distance in the Y-axis direction. Further, while the region 230 is a rectangle in the example in FIG. 7, the region 230 may have another shape such as an ellipse.

Then, when the line-of-sight direction determined by the determination unit 106 is decided to be within the limits of the region 230, the authentication unit 108 determines that the direction indicated by the direction information and the line-of-sight direction match and that the decision result is a success. When the line-of-sight direction determined by the determination unit 106 is decided to be not within the limits of the region 230, the authentication unit 108 determines that the direction indicated by the direction information and the line-of-sight direction do not match and that the decision result is an unsuccess.

The authentication unit 108 performs both the decision processing on a line-of-sight direction and the authentication processing using biometric information.

For the latter, the authentication unit 108 performs the authentication processing on a target person by checking preregistered biometric information (such as a feature value of the face) of a target person against biometric information (such as a feature value of the face) extracted from a facial image acquired by the acquisition unit 102.

A facial image used for the authentication processing by the authentication unit 108 is preferably a facial image used for determination of a line-of-sight direction of a target person by the determination unit 106 but may be a facial image of the target person captured at another timing. When a checking result of preregistered biometric information of a target person against biometric information extracted from a facial image acquired by the acquisition unit 102 indicates a score (such as a degree of similarity) equal to or greater than a reference value, the authentication unit 108 determines the result to be a success. When the checking result indicates a score less than a threshold value, the authentication unit 108 determines the result to be an unsuccess.

When a decision result of a line-of-sight direction indicates a success and a checking result of biometric information indicates a success, the authentication unit 108 determines that a target person himself or herself is actually in front of the screen 200 and face authentication of the target person is also successful and therefore determines that the authentication is successful. Note that the order of execution of the decision processing on a line-of-sight direction and execution of the authentication processing of biometric information by the authentication unit 108 is not particularly limited.

Thus, the authentication unit 108 determines authentication of a target person to be successful when a decision result of a line-of-sight direction indicates a success and a checking result of biometric information indicates a success and determines the authentication of the target person to be unsuccessful when at least one of the decision result of a line-of-sight direction and the checking result of biometric information does not indicate a success.

An authentication result by the authentication unit 108 may be notified to a provider of a service in need of the authentication. The notification method is not particularly limited, and a message may be transmitted to a preregistered destination [such as an electronic mail address and/or a phone number of a short message service (SMS)]. Alternatively, the authentication unit 108 may record an authentication result, authentication result information indicating a result being a success or an unsuccess for each user ID into the storage apparatus 120. The authentication result information may be viewed from a computer at the service provider.

Processing on the service providing side using an authentication result by the authentication unit 108 is preferably determined by the provider; and for example, when an authentication result by the authentication unit 108 is an unsuccess, processing of not permitting an operator U to use the service in need of the authentication may be performed. For example, processing of not permitting a login to a service, not permitting a start of an application, or suspending provision of a service in use may be performed.

### Operation Example

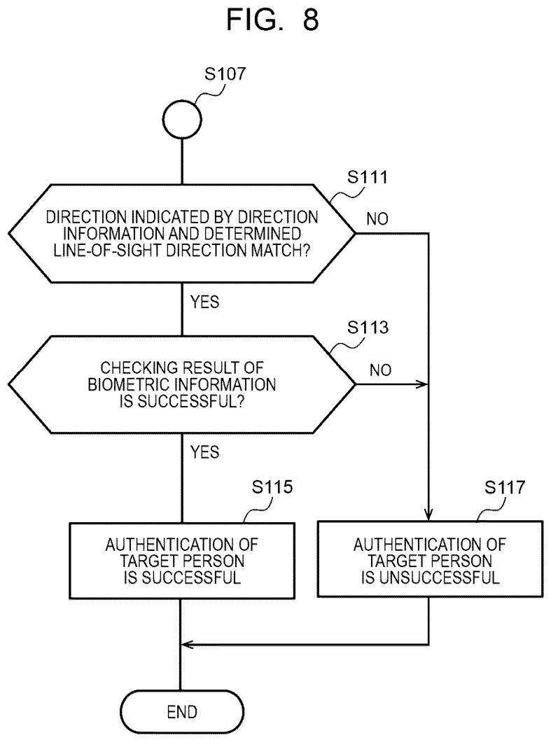

FIG. 8 is a flowchart illustrating a detailed operation example of the authentication processing in Step S107 in FIG. 2. The operation of the authentication apparatus 100 according to the present example embodiment will be described below by using FIG. 2 and FIG. 8.

First, the acquisition unit 102 acquires a facial image of a target person (Step S101 in FIG. 2). Note that the processing in Step S101 may be continuously executed during execution of this flow and is executed in at least Step S105 and Step S107.

As the first processing, the display processing unit 104 causes the screen 200 (such as FIG. 5(a)) of the display apparatus 30 in the operation terminal 20 to display a question and also causes the screen 200 to display direction information indicating a direction to be looked at by a target person when the target person answers the question (Step S103).

In accordance with the question and the direction information indicating a direction to be looked at by a target person to be a target of authentication (an operator U) that are indicated by the message display part 210 displayed on the screen 200, the operator U turns the line of sight in a direction indicating an answer to the question. In the example in FIG. 5(a), since the capital of the United States of America is not New York, the correct answer is represented by turning the line of sight to the left side of the screen 200.

As the second processing, the determination unit 106 determines a direction being looked at by the target person by using the facial image acquired by the acquisition unit 102 (Step S105). For example, it is assumed herein that the operator U looks at the left side of the screen 200. The determination unit 106 determines a line-of-sight direction by performing image processing on the facial image 250 of the operator U illustrated in FIG. 7(a).

As the third processing, the authentication unit 108 authenticates the target person by using the direction to be looked at by the target person when the target person answers the question (the left side of the screen 200 in this case) and the line-of-sight direction determined to be looked at by the target person by the determination unit 106 (Step S107). The authentication processing in Step S107 will be described by using the flowchart in FIG. 8.

As illustrated in FIG. 8, the authentication unit 108 first performs line-of-sight direction decision processing of deciding whether the direction indicated by the direction information and the line-of-sight direction determined by the determination unit 106 match (Step S111). For example, the authentication unit 108 decides whether the line-of-sight direction determined by the determination unit 106 is within the limits of the region 230. When the direction indicated by the direction information and the line-of-sight direction determined by the determination unit 106 match (YES in Step S111), the authentication processing of biometric information is performed (Step S113). The authentication processing of biometric information extracts a feature value of the face from the facial image of the operator U acquired by the acquisition unit 102 and checks the feature value against a preregistered feature value of the face of the operator U. When the checking result indicates a score equal to or greater than a reference value, the result is determined to be a success. When the checking result indicates a success (YES in Step S113), the authentication unit 108 determines the authentication of the target person to be successful (Step S115).

When the direction indicated by the direction information and the line-of-sight direction determined by the determination unit 106 do not match in the line-of-sight direction decision processing in Step S111 (NO in Step S111), the processing advances to Step S117. Further, the processing also advances to Step S117 when the checking result does not indicate a score equal to or greater than the reference value in the authentication processing of biometric information in Step S113 (NO in Step S113). In Step S117, the authentication unit 108 determines the authentication of the target person to be a failure.

When the result of the authentication processing is a success, the operator U can log into a service or can continue use of a service. On the other hand, when the result is a failure, the operator U cannot log into a service or cannot continue use of a service. In other words, the authentication result may be provided to a system on the service providing side.

As described above, the authentication apparatus 100 can perform authentication processing by causing, by the display processing unit 104, the screen 200 being look at by a person being an authentication target to display a question and direction information indicating a direction to be looked at when the target person answers the question, acquiring, by the acquisition unit 102, a facial image of a person looking at the screen 200, determining, by the determination unit 106, the line of sight of the person, and determining, by the authentication unit 108, that the person being the authentication target actually exists in front of the screen 200 by using the direction and the line-of-sight direction and therefore can provide an effect of enabling prevention of an improper act such as masquerading as a person being an authentication target by using an image or the like.

For example, the line-of-sight direction does not match when an improper act of masquerading as a target person by using a facial photograph, a dynamic image, a model, or the like of the authentication target is performed, and therefore, authentication does not succeed in the authentication apparatus 100. For example, performing the authentication processing by the authentication apparatus 100 according to the present example embodiment when an examination is remotely performed by using the operation terminal 20 enables highly precise confirmation of the person himself or herself actually existing at the location and taking the examination and prevention of a person improperly taking the examination by spoofing using a photograph, a dynamic image, a model, or the like.

### Second Example Embodiment

The present example embodiment is similar to the aforementioned example embodiment except that a standard answer to a question is set for each of a plurality of persons, and authentication based on validity of an answer by a target person is performed. Since an authentication apparatus 100 according to the present example embodiment includes the same configuration as that according to the first example embodiment, the apparatus will be described by using FIG. 1. Note that the configuration according to the present example embodiment may be combined with at least one of configurations according to other example embodiments without contradicting each other.

### Functional Configuration Example

A standard answer to the question is preset for each of a plurality of persons.

In first processing, a display processing unit 104 causes a screen 200 of a display apparatus 30 in an operation terminal 20 to display a question and also causes the screen 200 to display the direction information, based on the standard answer to the question. In third processing, an authentication unit 108 determines validity of an answer to a question by a target person by using the standard answer for the target person and a direction determined to be looked at by the target person and performs authentication of the target person, based on the validity.

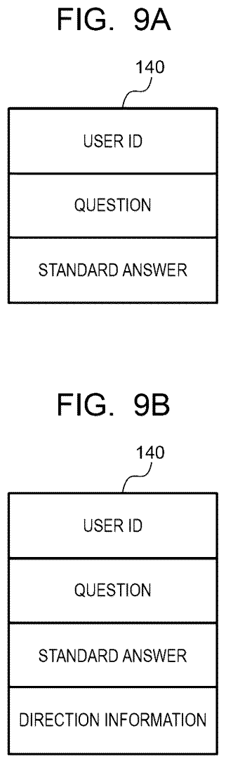

A standard answer to a question is an answer indicating a correct answer to the question and preferably has a content which only a target person himself or herself may know. FIG. 9 is a diagram illustrating data structure examples of question information 140. A user ID, a question, and an answer are associated with each other in question information 140 in an example in FIG. 9(a). A user ID, a question, an answer, and direction information are associated with each other in question information 140 in an example in FIG. 9(b).

### Operation Example

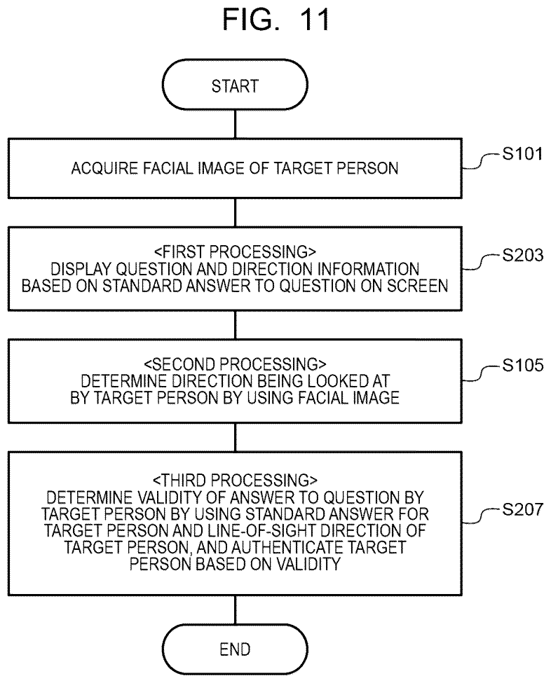

FIG. 11 is a flowchart illustrating an example of the operation of the authentication apparatus 100 according to the present example embodiment.

Step S101 and Step S105 are the same as those in the flowchart in FIG. 2.

First, an acquisition unit 102 acquires a facial image of a target person (Step S101 in FIG. 2). Note that the processing in Step S101 may be continuously executed during execution of this flow and is executed in at least Step S105 and Step S207.

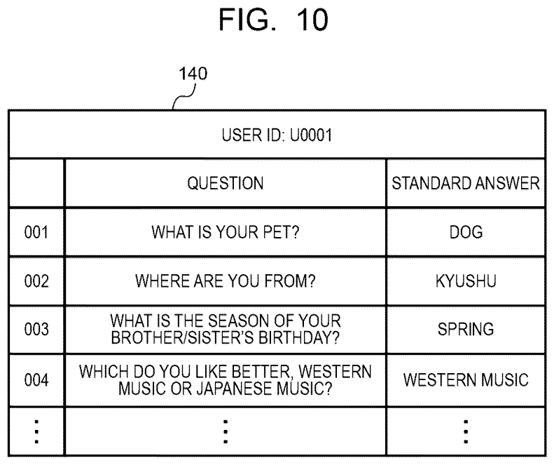

The display processing unit 104 refers to the question information 140 and acquires a question and a standard answer that are associated with the user ID of an operator U. FIG. 10 illustrates an example of the question information 140 with the data structure in FIG. 9(a) in which standard answers for a person with a user ID U0001 are stored. For example, the display processing unit 104 acquires a question 001 “What is your pet?” and a standard answer “dog” to the question in the question information 140.

Returning to FIG. 11, as the first processing, the display processing unit 104 causes the screen 200 of the display apparatus 30 in the operation terminal 20 to display the acquired question and also causes the screen 200 to display direction information indicating a direction to be looked at by the target person when the target person answers the question, based on the standard answer for the target person (Step S203).

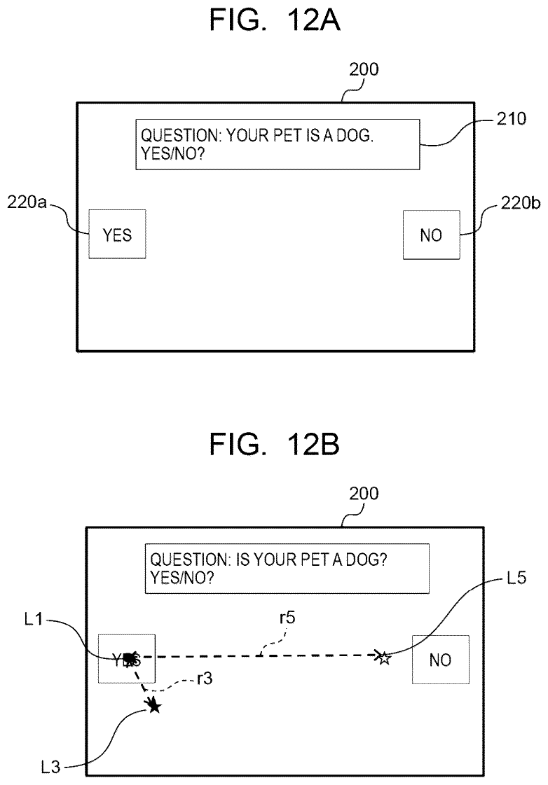

FIG. 12 is a diagram illustrating an example of the screen 200 displayed in Step S203. As illustrated in FIG. 12(a), the display processing unit 104 displays “Your pet is a dog. Yes/No?” in a message display part 210 of the screen 200 and also displays icons respectively indicating “Yes” and “No” in mark display parts 220 at predetermined positions in the screen 200. Since the standard answer for the target person is “dog,” a direction to be looked at by the target person is a position L1 (FIG. 12(b)) where “Yes” is displayed. The display processing unit 104 stores coordinate information of the position L1 where “Yes” is displayed into the question information 140 in FIG. 9(b) as direction information.

As described above, the position of a standard answer displayed by the display processing unit 104 is preferably changed on each occasion. Therefore, the display processing unit 104 stores direction information indicating the display position of a standard answer into the question information 140.

Then, as second processing, a determination unit 106 determines a direction being looked at by the target person by using the facial image acquired by the acquisition unit 102 (Step S105).

Then, as the third processing, the authentication unit 108 determines validity of the answer by the target person by using the standard answer for the target person and a line-of-sight direction determined to be looked at by the target person (Step S207). For example, validity may be represented by a value (a distance r3 or r5) indicating the displacement between direction information indicating a direction to be looked at by a target person, the direction being related to the standard answer (the position L1), and position information indicating the line-of-sight direction (a position L3 or L5) in the example in FIG. 12(b). In other words, validity decreases as the distance increases.

The authentication unit 108 authenticates the target person, based on the validity determined in Step S207 (Step S209). For example, when the position of the line-of-sight direction determined by the determination unit 106 is L3 in the example in FIG. 12(b), the distance r3 to the position L1 of the standard answer is equal to or less than a threshold value; and therefore, the authentication unit 108 determines that the answer by the target person is valid. On the other hand, for example, when the position of the line-of-sight direction determined by the determination unit 106 is L5, the distance r5 to the position L1 of the standard answer is not equal to or less than the threshold value; and therefore, the authentication unit 108 determines that the answer by the target person is not valid.

Variations of the determination processing of validity of an answer will be described.

### <First Determination Processing>

In the third processing, the authentication unit 108 determines a direction related to a standard answer for a target person as a standard direction and determines validity of an answer to a question by the target person by using the determined standard direction and a direction determined to be looked at by the target person.

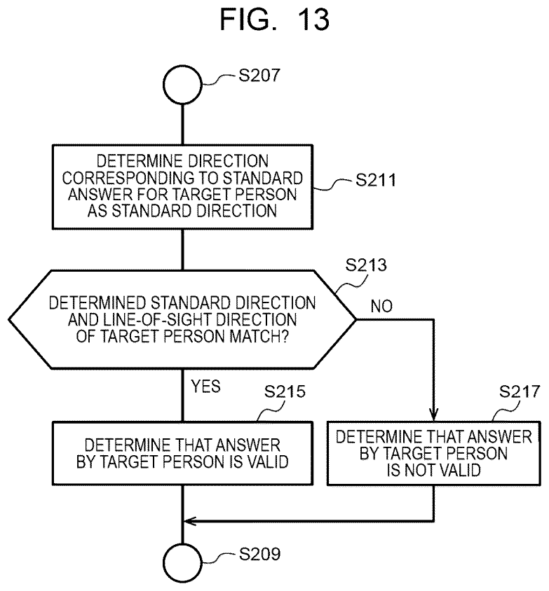

FIG. 13 is a diagram illustrating a flowchart indicating a first determination processing example in Step S207 in FIG. 11. The authentication unit 108 reads direction information related to a standard answer for a person with a user ID U0001 from the question information 140 in FIG. 10(b) and determines the direction as a standard direction (Step S211). Then, the authentication unit 108 decides whether the determined standard direction (such as the position L1 in FIG. 12(b)) and the line-of-sight direction of the target person (such as the position L3 or L5 in FIG. 12(c)) match (Step S213).

As described above, when the distance r3 or r5 between the positions of the standard direction and the line-of-sight direction is equal to or less than the threshold value, the authentication unit 108 decides that the standard direction and the line-of-sight direction match. When the directions are decided to match (YES in Step S213), the authentication unit 108 determines that the answer by the target person is valid (Step S215). When the directions are decided not to match (NO in Step S213), the authentication unit 108 determines that the answer by the target person is not valid (Step S217).

Thus, the authentication method by the first determination processing determines a standard direction related to a standard answer for a target person displayed on the screen 200 by the display processing unit 104 from the question information 140 and determines validity of an answer by using a line-of-sight direction determined by the determination unit 106 and the standard direction; and therefore, even when the display position of a standard answer is randomly changed, the display position can be stored in the question information 140; and therefore, validity of an answer by an authentication target person can be easily determined.

### <Second Determination Processing>

In the third processing, the authentication unit 108 determines an answer to a question indicated by a direction determined to be looked at by a target person and determines validity of an answer to the question by the target person by using the determined answer and a standard answer for the target person.

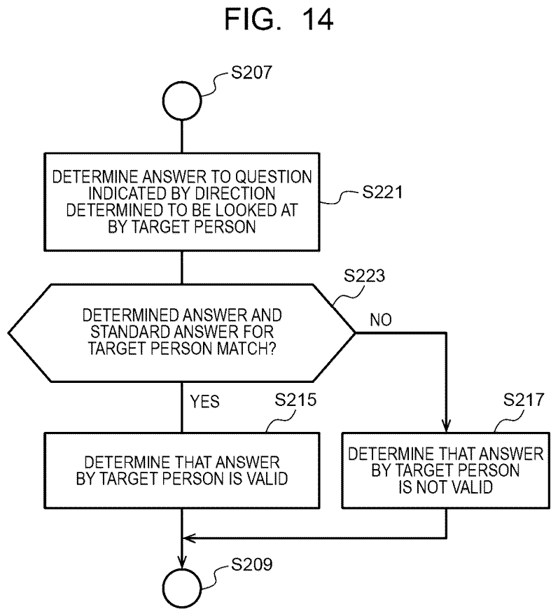

FIG. 14 is a diagram illustrating a flowchart indicating a second determination processing example in Step S207 in FIG. 11. The authentication unit 108 determines an answer indicated by the line-of-sight direction of a target person (Step S221).

In this example, the display processing unit 104 stores position information of each of mark display parts 220 respectively displaying icons indicating “Yes” and “No” in association with a question as the question information 140. At this time, the question information 140 is stored in such a way as to also allow determination that the icon indicating “Yes” indicates a standard answer “The pet is a dog.”

The authentication unit 108 computes a value (a distance) indicating the displacement between the position of a line-of-sight direction and the position of each answer and determines an answer with a distance equal to or less than a threshold value. For example, when the line-of-sight direction is the position L5 in the example in FIG. 12(b), the distance between the position L5 of the line-of-sight direction and the icon “No” is equal to or less than the threshold value, and the distance to the display position of the icon indicating “Yes” is not equal to or less than the threshold value. Therefore, the authentication unit 108 determines that the answer indicated by the line-of-sight direction is “No.”

Then, the authentication unit 108 acquires the question and the standard answer in the question information 140 and, since the standard answer is “Yes” indicating “The pet is a dog,” decides that the determined answer and the standard answer do not match (NO in Step S223). The processing advances to Step S217, and the authentication unit 108 determines that the answer by the target person is not valid.

For example, when a line-of-sight direction is the position L3 in the example in FIG. 12(b), the distance between the position L3 of the line-of-sight direction and the icon “Yes” is equal to or less than the threshold value, and the distance to the display position of the icon indicating “No” is not equal to or less than the threshold value. Therefore, the authentication unit 108 determines that the answer indicated by the line-of-sight direction is “Yes.”

Then, the authentication unit 108 acquires the question and the standard answer in the question information 140 and, since the standard answer is “Yes” indicating “The pet is a dog,” decides that the determined answer and the standard answer match (YES in Step S223). The processing advances to Step S215, and the authentication unit 108 determines that the answer by the target person is valid.

Thus, the authentication method by the second determination processing stores a standard answer for a target person displayed on the screen 200 by the display processing unit 104 and display position information of direction information related to another answer into the question information 140 and, by the authentication unit 108, determines an answer related to position information indicated by a line-of-sight direction determined by the determination unit 106 and determines validity of the answer; and therefore, even when the display position of a standard answer is randomly changed, the display position can be stored in the question information 140; and therefore, validity of an answer by an authentication target person can be easily determined.

As described above, a standard answer to a question is provided for each authentication target person, and the authentication unit 108 determines validity of an answer by using a standard answer for the authentication target person in the authentication apparatus 100; and therefore, the authentication apparatus 100 provides the effects provided by the aforementioned example embodiments and can further detect and prevent an improper act such as proxy by a person other than an authentication target person himself or herself.

### Third Example Embodiment

FIG. 15 is a functional block diagram illustrating a functional configuration example of an authentication apparatus 100 according to an example embodiment. The present example embodiment is similar to the second example embodiment except for including a configuration in which a standard answer to a question can be accepted and registered for each target person. Note that the configuration according to the present example embodiment may be combined with at least one of configurations according to other example embodiments without contradicting each other.

### Functional Configuration Example

The authentication apparatus 100 further includes an acceptance unit 110 in addition to the configuration of the authentication apparatus 100 in FIG. 1. The acceptance unit 110 accepts a standard answer for each of a plurality of persons and stores the standard answer into a storage apparatus 120 in association with the person.

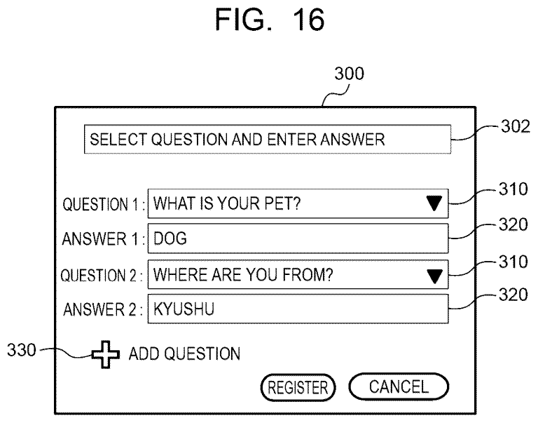

Specifically, for example, the acceptance unit 110 causes a display apparatus 30 to display a registration screen 300 causing an operator U to register a standard answer after authentication processing of the operator U. The registration screen 300 in FIG. 16 includes a list display part 310 for selecting a question and an entry field 320 for entering a standard answer to the question. The registration screen 300 further includes an icon 330 for adding a question to be registered, a registration button 340 for registering the question and the standard answer that are specified on the registration screen 300, and a cancel button 350 for canceling the specified content and closing the registration screen 300.

The list display part 310 is a user interface, such as a drop-down list or a drum roll, for accepting selection of a question to be registered from among a plurality of predetermined questions. The entry field 320 is a user interface, such as a text box, for entering text. Alternatively, the entry field 320 may have a form of selecting a standard answer from among a plurality of alternatives. In that case, the entry field 320 is a user interface such as a drop-down list or a drum roll.

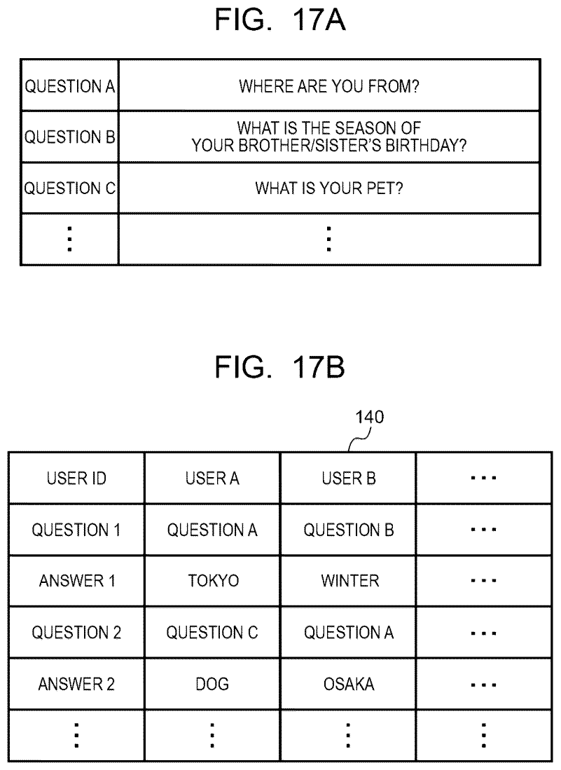

FIG. 17(a) is a diagram illustrating an example of a plurality of predetermined questions. FIG. 17(b) is a diagram illustrating an example of data of question information 140 storing standard answers to questions registered for each user. A question and a standard answer to the question that are accepted by the acceptance unit 110 are stored into the question information 140 in FIG. 17(b) in association with a user ID.

Examples of various conceivable timings for performing a procedure for registering a question and a standard answer for each target person by the acceptance unit 110 are listed below but are not limited thereto. Further, a plurality of timings may be combined.
(1) Perform the procedure in advance at use registration of a service or the like.
(2) Perform the procedure at a login for service use.
(3) Perform the procedure at a predetermined timing during service use.

Note that execution of the procedure at any timing preferably follows authentication processing using authentication information such as a facial image or the like of a person in front of the registration screen 300 displayed on the display apparatus 30 in an operation terminal 20.

When a person lets another person to whom proxy is requested know a content of a question to begin with in a configuration in which a content which only the person himself or herself may know is registered as an answer to a question, a question for each target person may become meaningless. Therefore, the procedure for registering questions by the acceptance unit 110 may be performed in such a way as to randomly output questions initially at the start of service use or at a predetermined timing during service use and cause the operator U to register answers as is the case with the aforementioned items (2) or (3) and subsequently cause a question randomly selected from the previously registered questions to be displayed on a screen 200 during service use.

The predetermined timing is regularly, irregularly, or when a facial image acquired by an acquisition unit 102 satisfies a predetermined criterion and may be the same as at least one of a predetermined timing and a predetermined criterion in fifth and sixth example embodiments to be described later.

Thus, a detection unit 112 in the authentication apparatus 100 according to the present example embodiment further accepts a standard answer for each of a plurality of persons and stores the standard answer into the storage apparatus 120 as question information 140. Thus, the present example embodiment can provide effects similar to those of the aforementioned example embodiments and can perform authentication processing by using an answer which only the person himself or herself may know to a question, and therefore can detect and prevent an improper act such as spoofing by a proxy or a model.

### Fourth Example Embodiment

The present example embodiment differs from the aforementioned example embodiments in including a configuration in which a plurality of alternatives to a question are displayed, and direction information indicating a direction to be looked at by a target person is displayed at selection. Since an authentication apparatus 100 according to the present example embodiment includes the same configuration as that according to the first example embodiment, the apparatus will be described by using FIG. 1. Note that the configuration according to the present example embodiment may be combined with at least one of configurations according to other example embodiments without contradicting each other.

### Functional Configuration Example

In first processing, a display processing unit 104 causes a screen 200 to display a plurality of alternatives related to a question and also causes the screen 200 to display, for each of the plurality of alternatives, a direction to be looked at by a target person when the target person selects the alternative as direction information.

An authentication unit 108 performs third processing by using a direction to be looked at by a target person, the direction being related to an alternative indicating a correct answer to a question, and a direction determined to be looked at by the target person.

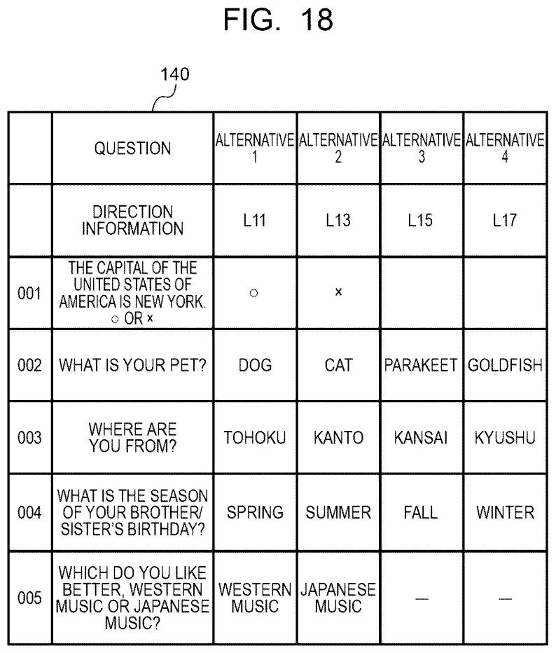

FIG. 18 is a diagram illustrating examples of a plurality of alternatives to a question. A plurality of alternatives and direction information indicating a direction to be looked at for each alternative are associated with each other for each question in question information 140. Then, information allowing determination of an alternative indicating a correct answer to a question is stored in the question information 140 in an associated manner. For example, a correct answer to a question 001 being an alternative 2 is stored in the question information 140 in an associated manner.

In a combination with the aforementioned second example embodiment, information allowing determination of an alternative being a standard answer to a question may be further stored in the question information 140 in an associated manner for each target person. For example, a standard answer to a question 002 for a user A being an alternative 2 is stored in the question information 140 in an associated manner.

### Operation Example

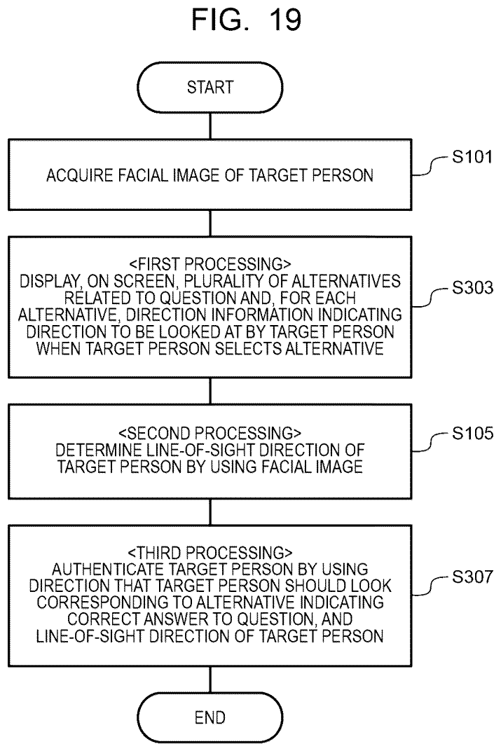

FIG. 19 is a flowchart illustrating an example of the operation of the authentication apparatus 100 according to the present example embodiment.

Step S101 and Step S105 are the same as those in the flowchart in FIG. 2.

First, an acquisition unit 102 acquires a facial image of a target person (Step S101 in FIG. 2). Note that the processing in Step S101 may be continuously executed during execution of this flow and is executed at least in Step S105 and Step S207.

As the first processing, the display processing unit 104 displays a plurality of alternatives related to a question and, for each alternative, direction information indicating a direction to be looked at by a target person when the target person selects the alternative on the screen 200 of a display apparatus 30 in an operation terminal 20 (Step S303).

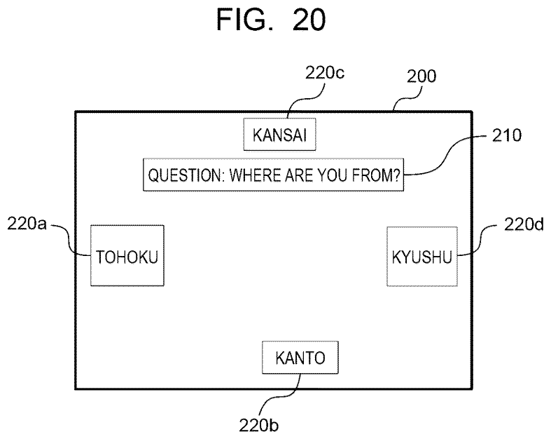

FIG. 20 is a diagram illustrating an example of the screen 200 displayed in Step S303. As illustrated in FIG. 20, the display processing unit 104 displays a question “Where are you from?” in a message display part 210 in the screen 200 and also displays icons respectively indicating alternatives in mark display parts 220 at predetermined positions in the screen 200. It is assumed that a standard answer being “Kanto” for a target person is stored in the question information 140.

A direction to be looked at by the target person is a position L13 where an alternative 2 “Kanto” is displayed (FIG. 18). While direction information is previously associated with each alternative in the example in FIG. 18, the display processing unit 104 may change the display position of an alternative on each occasion in another example. Direction information indicating a position displayed by the display processing unit 104 may be stored in the question information 140 in an associated manner.

Then, as second processing, a determination unit 106 determines a direction being looked at by the target person by using the facial image acquired by the acquisition unit 102 (Step S105).

Then, as the third processing, the authentication unit 108 authenticates the target person by using the direction in which the target person should look and the direction in which the target person is determined to be looking (Step S307). For example, the authentication unit 108 decides whether the position L13 being the direction in which the target person should look and displaying the alternative “Kanto”, and position information indicating a line-of-sight direction match. The authentication processing in Step S307 is similar to that in one of the aforementioned example embodiments.

Thus, in the authentication apparatus 100 according to the present example embodiment, the display processing unit 104 further causes a plurality of alternatives related to a question to be displayed and causes a direction in which an authentication target person should look when the authentication target person selects an alternative to be displayed on the screen 200 as direction information, and the authentication unit 108 performs the third processing by using a direction to be looked at by the authentication target person, the direction being related to an alternative indicating the correct answer to the question, and a line-of-sight direction. The present example embodiment can provide effects similar to those of the aforementioned example embodiments and enables an operator U to select an answer by a simple operation of selection from among a plurality of alternatives to a question.

### Fifth Example Embodiment

The present example embodiment is similar to the aforementioned example embodiments except that first processing by a display processing unit 104, second processing by a determination unit 106, and third processing by an authentication unit 108 are executed at a predetermined timing. Since an authentication apparatus 100 according to the present example embodiment includes the same configuration as that according to the first example embodiment, the apparatus will be described by using FIG. 1. Note that the configuration according to the present example embodiment may be combined with at least one of configurations according to other example embodiments without contradicting each other.

### Functional Configuration Example

The authentication unit 108 executes authentication processing using a facial image of a person, and the display processing unit 104, the determination unit 106, and the authentication unit 108 respectively execute the first processing, the second processing, and the third processing at a predetermined timing after successful authentication of the target person.

Examples of the predetermined timing include the following. A plurality of timings below may be combined.
(1) The predetermined timing is regularly or irregularly.
(2) The predetermined timing is when a facial image of a target person satisfies a predetermined criterion in the authentication processing by the authentication unit 108.

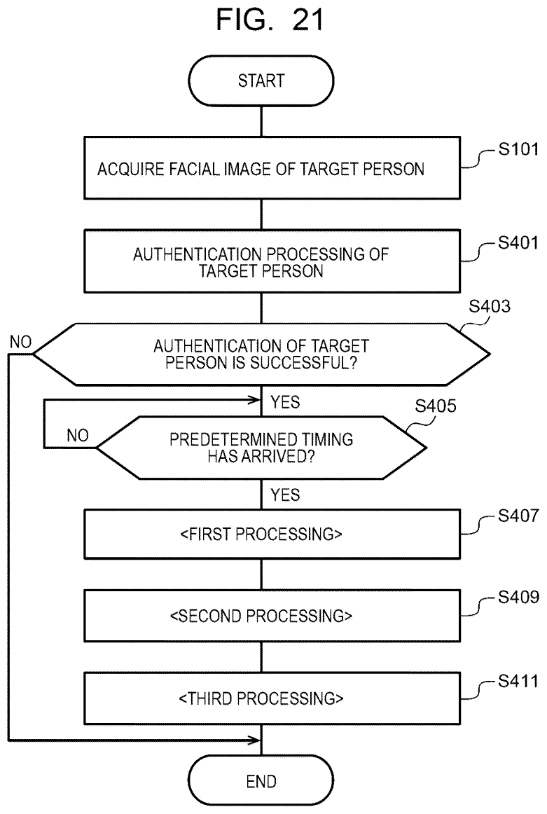

FIG. 21 is a flowchart illustrating an example of the operation of the authentication apparatus 100 according to the example embodiment.

Step S101 is the same as that in the flowchart in FIG. 2.

First, the acquisition unit 102 acquires a facial image of a target person (Step S101). Note that the processing in Step S101 may be continuously executed during execution of this flow and is executed at least in Step S401, Step S409, and Step S411.

Then, the authentication unit 108 executes the authentication processing using the facial image of the person (Step S401). When a checking result of a feature value of a face extracted from the facial image against a registered feature value of the face indicates a score equal to or greater than a reference value, the authentication is decided to be successful (YES in Step S403), and the authentication unit 108 decides whether the predetermined timing has arrived (Step S405).

When the predetermined timing arrives (YES in Step S405), the display processing unit 104 executes the first processing (Step S407), the determination unit 106 executes the second processing (Step S409), and the authentication unit 108 executes the third processing (Step S411).

Each type of processing executed in Step S407 to Step S411 may be the same as that in one of the aforementioned example embodiments.

Further, the authentication processing by the authentication unit 108 in Step S401 may be executed at an initial login.

Thus, whether a person looking at a screen 200 of a display apparatus 30 in an operation terminal 20 at an initial login is an authentication target person can be determined by the authentication processing based on biometric information at the start of service use.

When the predetermined timing is regularly or irregularly, for example, arrival of the predetermined timing may be detected by setting a timer in Step S405. A time setting of the timer may employ at least one of timings being at every fixed time, at fixed intervals, and at random. A plurality of time settings of the timer may be combined.

By performing the processing at regular or irregular predetermined timings, the authentication processing of a target person can be performed repeatedly, and therefore, an improper act such as spoofing by a proxy or a model can be detected and prevented not only at the start of service use but also during the use.

When the predetermined timing is when a facial image of a target person satisfies a predetermined criterion in the authentication processing by the authentication unit 108, the authentication unit 108 decides whether the facial image of the target person acquired by the acquisition unit 102 satisfies the predetermined criterion in Step S405. Then, when the predetermined criterion is satisfied, the authentication unit 108 determines that the predetermined timing has arrived and advances to Step S407.

The predetermined criterion includes a score indicating a result of the authentication processing using a facial image of a target person being equal to or less than a reference value.

When a facial image of a target person satisfies the predetermined criterion, such as a score indicating a result of the authentication processing based on the facial image, that is, a degree of similarity, is low, an improper act such as disguise by a proxy or spoofing by a dynamic image, a model, or the like may be under way, and therefore an improper act can be detected and prevented by performing the first to third processing.

As described above, the authentication apparatus 100 initially performs the authentication processing using a facial image of a person by the authentication unit 108 and executes the first to third processing at the predetermined timing and therefore can provide effects similar to those provided by the aforementioned example embodiments and further can detect and prevent an improper act such as spoofing by a proxy or a model at the start of service use and also during the use.

### Sixth Example Embodiment

FIG. 22 is a functional block diagram illustrating a functional configuration example of an authentication apparatus 100 according to an example embodiment. The present example embodiment is similar to the aforementioned fifth example embodiment except for including a configuration in which an improper act of hiding the face by sunglasses, a mask, or the like is detected. Note that the configuration according to the present example embodiment may be combined with at least one of configurations according to other example embodiments without contradicting each other.

### Functional Configuration Example

The authentication apparatus 100 further includes a detection unit 112 in addition to the configuration of the authentication apparatus 100 in FIG. 1. The detection unit 112 detects at least one of a predetermined part of the face and a predetermined wearing article from a facial image of a target person, Alternatively, the detection unit 112 acquires a background image of a facial image of a target person and detects a change in the background image.

The predetermined criterion includes at least one item out of inability to detect a predetermined part of the face of a target person and detection of a predetermined wearing article when authentication processing is performed.

Furthermore, the predetermined criterion may include temporary inability to acquire a facial image of a target person in another example.

Examples of the predetermined wearing article include objects hiding or changing part of the head by being worn, such as a mask, glasses, sunglasses, headwear, a false mustache/beard, a wig, and an accessory. The detection unit 112 may further detect a change in a body region part connecting to the face of an authentication target person by processing an image of the body region part of the person. For example, the detection unit 112 may detect a change in clothes of a target person.

In other words, the detection unit 112 detects an improper act, such as spoofing by another person.

### Operation Example

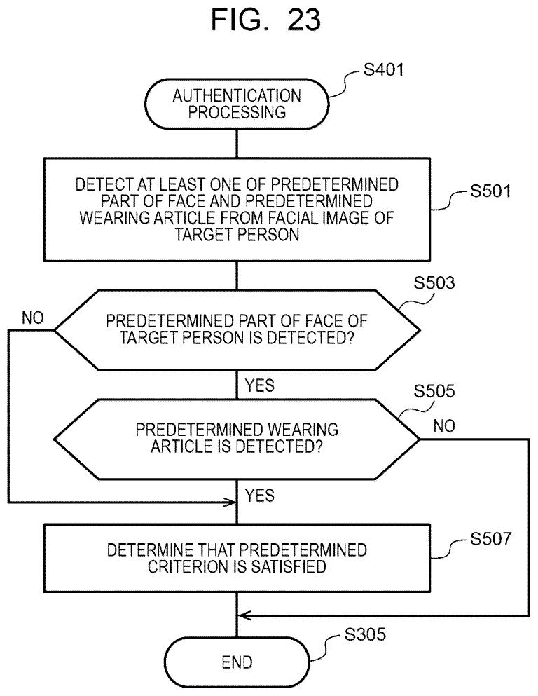

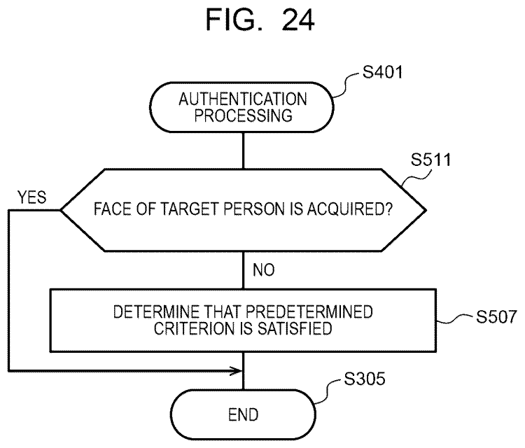

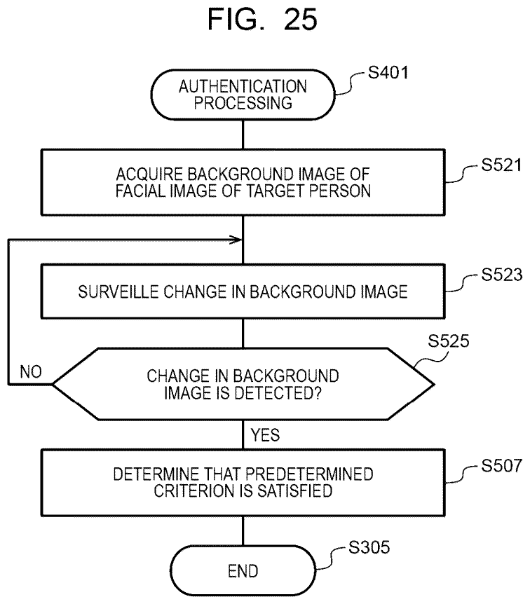

FIG. 23 to FIG. 25 are flowcharts for illustrating variations of a method for processing improper act detection by the detection unit 112 in the authentication processing in Step S401 in FIG. 21. FIG. 23 illustrates an example of detecting a predetermined wearing article, FIG. 24 illustrates an example of not being able to acquire a face, and FIG. 25 illustrates an example of detecting a change in a background.

### Operation Example 1

An operation example of the authentication processing of detecting a predetermined wearing article will be described by using FIG. 23.

First, the detection unit 112 detects at least one of a predetermined part of the face and a predetermined wearing article from a facial image of a target person acquired by an acquisition unit 102 (Step S501). Then, when a predetermined part of the face of the target person cannot be detected by the detection unit 112 (NO in Step S503), the processing advances to Step S507, and the authentication unit 108 determines that the predetermined criterion is satisfied.

When the predetermined part of the face of the target person is detected by the detection unit 112 (YES in Step S503), the processing advances to Step S505. Then, when a predetermined wearing article is detected by the detection unit 112 (YES in Step S505), the processing advances to Step S507, and the authentication unit 108 determines that the predetermined criterion is satisfied. Then, when a predetermined wearing article is not detected by the detection unit 112 (NO in Step S505), the predetermined criterion is not satisfied, and therefore, Step S507 is bypassed, and the processing is ended.

The flow in FIG. 23 may be executed regularly and repeatedly during service use.

Thus, in the operation example 1 of the authentication processing method, the detection unit 112 detects a predetermined part of the face or a predetermined wearing article from a facial image acquired from the acquisition unit 102, and when a predetermined part is not detected or a predetermined wearing article is detected from the facial image, the authentication unit 108 determines that the predetermined criterion is satisfied; and therefore, a display processing unit 104, a determination unit 106 and the authentication unit 108 can respectively execute first processing, second processing, and third processing. Therefore, an improper act, such as spoofing by disguise by a proxy or the like, can be detected and prevented.

### Operation Example 2

An operation example of the authentication processing when a face cannot be acquired will be described by using FIG. 24.

First, the authentication unit 108 decides whether a facial image acquired by the acquisition unit 102 includes the face of a target person, that is, whether the face of the target person is acquired (Step S511). When the face of the target person cannot be acquired (Step S511), the processing advances to Step S507, and the authentication unit 108 determines that the predetermined criterion is satisfied.

The flow in FIG. 24 may be executed regularly and repeatedly during service use.

Thus, in the operation 2 of the authentication processing method, when a facial image does not include the face of a target person, the authentication unit 108 determines that the predetermined criterion is satisfied; and therefore, the display processing unit 104, the determination unit 106, and the authentication unit 108 can respectively execute the first processing, the second processing, and the third processing. Therefore, when the person himself or herself is replaced during service use in order to perform an improper act such as proxy by another person or spoofing by a dynamic image, a model, or the like, status of temporary inability to acquire the face of the person himself or herself can be detected, and therefore, the improper act can be prevented.

### Operation Example 3

An operation example of the authentication processing of detecting a change in a background will be described by using FIG. 25.

First, the detection unit 112 acquires a background image of a facial image of a target person acquired by the detection unit 112 (Step S521). The detection unit 112 surveilles change in the background image acquired in Step S521 (Step S523). When detecting a change in the background image (YES in Step S525), the detection unit 112 advances to Step S507, and the authentication unit 108 determines that the predetermined criterion is satisfied. Until a change in the background image is detected (NO in Step S525), the surveillance is performed (the processing returns to Step S523).

The flow in FIG. 25 may be continuously executed during service use.

Thus, in the operation example 3 of the authentication processing method, the predetermined criterion is determined to be satisfied when a change in a background image of a facial image acquired by the acquisition unit 102 is detected by the detection unit 112, and therefore, an improper act such as spoofing by a proxy or a model can be detected and prevented not only at the start of service use but also during the use. Therefore, when switching from the person himself or herself is performed in order to perform an improper act such as proxy by another person or spoofing by a dynamic image, a model, or the like, status of change or temporary darkening of the background image can be detected, and therefore, the improper act can be prevented.

As described above, the present example embodiment can provide effects similar to those of the aforementioned example embodiments and when suspected status of an improper act is detected by the detection unit 112, enables detection and prevention of an improper act, such as spoofing by a proxy, a model or the like, not only at the start of service use but also during the use.

While the example embodiments of the present invention have been described above with reference to the drawings, the example embodiments are exemplifications of the present invention, and various configurations other than those described above may also be employed.

Further, while a plurality of processes (processing) are described in a sequential order in each of a plurality of flowcharts used in the aforementioned description, the execution order of processes executed in each example embodiment is not limited to the order of description. The order of the illustrated processes may be modified without affecting the contents in each example embodiment. Further, the aforementioned example embodiments may be combined without contradicting each other.

While the present invention has been described with reference to the example embodiments, the present invention is not limited to the aforementioned example embodiments. Various changes and modifications that may be understood by a person skilled in the art may be made to the configurations and details of the present invention without departing from the scope of the present invention.

Note that, when information about a user (an operator U) is acquired and used in the present invention, the acquisition and the use are assumed to be performed legally.

The whole or part of the example embodiments disclosed above may also be described as, but not limited to, the following supplementary notes.

1. An authentication apparatus including:
an acquisition unit that acquires a facial image of a target person being a person to be a target of authentication;
a display processing unit that performs first processing of causing a screen that can be looked at by the target person to display a question and also causing the screen to display direction information indicating a direction to be looked at by the target person when the target person answers the question;
a determination unit that performs second processing of determining a direction being looked at by the target person by using the facial image; and
an authentication unit that performs third processing of, by using a direction to be looked at by the target person when the target person answers the question and a direction determined to be looked at by the target person, authenticating the person.
   2. The authentication apparatus according to 1., wherein
a standard answer to the question is preset for each of a plurality of persons,
in the first processing, the display processing unit causes the screen to display the question and also causes the screen to display the direction information, based on the standard answer, and
in the third processing, the authentication unit determines validity of an answer to the question by the target person by using the standard answer for the target person and a direction determined to be looked at by the target person and performs authentication of the target person, based on the validity.
   3. The authentication apparatus according to 2., wherein,
in the third processing, the authentication unit determines the direction related to the standard answer for the target person as a standard direction and determines the validity of an answer to the question by the target person by using the determined standard direction and a direction determined to be looked at by the target person.
   4. The authentication apparatus according to 2., wherein,
in the third processing, the authentication unit determines an answer to the question, the answer being indicated by a direction determined to be looked at by the target person, and determines the validity of an answer to the question by the target person by using the determined answer and the standard answer for the target person.
   5. The authentication apparatus according to any one of 2. to 4., further including
an acceptance unit that accepts the standard answer for each of a plurality of persons and stores the standard answer into a storage unit in association with the person.
   6. The authentication apparatus according to any one of 1. to 5., wherein,
in the first processing, the display processing unit
   causes the screen to display a plurality of alternatives related to the question, and
   for each of the plurality of alternatives, causes the screen to display, as the direction information, the direction to be looked at by the target person when the target person selects the alternative, and
the authentication unit performs the third processing by using a direction to be looked at by the target person, the direction being related to an alternative indicating a correct answer to a question, and a direction determined to be looked at by a target person.
   7. The authentication apparatus according to any one of 1. to 6., wherein
the authentication unit executes authentication processing using a facial image of the person, and
the display processing unit, the determination unit, and the authentication unit respectively execute the first processing, the second processing, and the third processing at a predetermined timing after successful authentication of the target person.
   8. The authentication apparatus according to 7., wherein
the predetermined timing is regularly or irregularly.
   9. The authentication apparatus according to 7, or 8., wherein
the predetermined timing is when a facial image of the target person satisfies a predetermined criterion in the authentication processing by the authentication unit.
   10. The authentication apparatus according to any one of 7. to 9., wherein
the authentication unit executes authentication processing using a facial image of the target person at an initial login, and
the display processing unit, the determination unit, and the authentication unit respectively execute the first processing, the second processing, and the third processing after successful authentication of the target person.
   11. The authentication apparatus according to 9, or 10., wherein
the predetermined criterion includes a score indicating a result of the authentication processing using a facial image of the target person being equal to or less than a reference value.
   12. The authentication apparatus according to any one of 9. to 11., further including
a detection unit that detects at least one of a predetermined part of a face and a predetermined wearing article from a facial image of the target person, wherein
the predetermined criterion includes, when the authentication processing is performed, at least one item out of inability to detect a predetermined part of a face of the target person and detection of the predetermined wearing article.
   13. The authentication apparatus according to any one of 9. to 12., wherein
the predetermined criterion includes temporary inability to acquire a facial image of the target person.
   14. The authentication apparatus according to any one of 11. to 13., further including
a detection unit that acquires a background image of a facial image of the target person and detects a change in the background image, wherein
the predetermined criterion includes detection of a change in the background image.
   15. An authentication system including:
an information processing apparatus; and
an authentication apparatus connected to the information processing apparatus through a network, wherein
the information processing apparatus includes:
   a display unit that displays a screen that can be looked at by a person to be a target of authentication; and
   an image capture unit that generates a facial image of the person looking at the screen, and
the authentication apparatus includes:
   an acquisition unit that acquires a facial image of a target person being a person to be a target of authentication;
   a display processing unit that performs first processing of causing a screen of the display unit in the information processing apparatus, the screen being able to be looked at by the target person, to display a question and also causing the screen to display direction information indicating a direction to be looked at by the target person when the target person answers the question;
   a determination unit that performs second processing of determining a direction being looked at by the target person by using the facial image; and
   an authentication unit that performs third processing of, by using a direction to be looked at by the target person when the target person answers the question and a direction determined to be looked at by the target person, authenticating the person.
      16. The authentication system according to 15., wherein
a standard answer to the question is preset for each of a plurality of persons, and
in the authentication apparatus,
   in the first processing, the display processing unit causes the screen of the display unit in the information processing apparatus to display the question and also causes the screen to display the direction information, based on the standard answer, and
   in the third processing, the authentication unit determines validity of an answer to the question by the target person by using the standard answer for the target person and a direction determined to be looked at by the target person and performs authentication of the target person, based on the validity.
      17. The authentication system according to 16., wherein,
in the authentication apparatus,
   in the third processing, the authentication unit determines the direction related to the standard answer for the target person as a standard direction and determines the validity of an answer to the question by the target person by using the determined standard direction and a direction determined to be looked at by the target person.
      18. The authentication system according to 16., wherein,
in the authentication apparatus,
   in the third processing, the authentication unit determines an answer to the question, the answer being indicated by a direction determined to be looked at by the target person, and determines the validity of an answer to the question by the target person by using the determined answer and the standard answer for the target person.
      19. The authentication system according to any one of 16. to 18., wherein
the authentication apparatus further includes
   an acceptance unit that accepts the standard answer for each of a plurality of persons and stores the standard answer into a storage unit in association with the person.
      20. The authentication system according to any one of 15. to 19., wherein,
in the authentication apparatus,
   in the first processing, the display processing unit
      causes the screen of the display unit in the information processing apparatus to display a plurality of alternatives related to the question, and
      for each of the plurality of alternatives, causes the screen to display, as the direction information, the direction to be looked at by the target person when the target person selects the alternative, and
   the authentication unit performs the third processing by using a direction to be looked at by the target person, the direction being related to an alternative indicating a correct answer to a question, and a direction determined to be looked at by a target person.
      21. The authentication system according to any one of 15. to 20., wherein,
in the authentication apparatus,
   the authentication unit executes authentication processing using a facial image of the person, and
   the display processing unit, the determination unit, and the authentication unit respectively execute the first processing, the second processing, and the third processing at a predetermined timing after successful authentication of the target person.
      22. The authentication system according to 21., wherein the predetermined timing is regularly or irregularly.
      23. The authentication system according to 21. or 22., wherein
the predetermined timing is when a facial image of the target person satisfies a predetermined criterion in the authentication processing by the authentication unit.
   24. The authentication system according to any one of 21. to 23., wherein,
in the authentication apparatus,
   the authentication unit executes authentication processing using a facial image of the target person at an initial login, and
   the display processing unit, the determination unit, and the authentication unit respectively execute the first processing, the second processing, and the third processing after successful authentication of the target person.
      25. The authentication system according to 23. or 24., wherein
the predetermined criterion includes a score indicating a result of the authentication processing using a facial image of the target person being equal to or less than a reference value.

26. The authentication system according to any one of 23. to 25., wherein
the authentication apparatus further includes a detection unit that detects at least one of a predetermined part of a face and a predetermined wearing article from a facial image of the target person, and
the predetermined criterion includes, when the authentication processing is performed, at least one item out of inability to detect a predetermined part of a face of the target person and detection of the predetermined wearing article.
   27. The authentication system according to any one of 23. to 26., wherein
the predetermined criterion includes temporary inability to acquire a facial image of the target person.
   28 The authentication system according to any one of claims 25. to 27., wherein
the authentication apparatus further includes a detection unit that acquires a background image of a facial image of the target person and detects a change in the background image, and
the predetermined criterion includes detection of a change in the background image.
   29. An authentication method including, by one or more computers:
acquiring a facial image of a target person being a person to be a target of authentication;
performing first processing of causing a screen that can be looked at by the target person to display a question and also causing the screen to display direction information indicating a direction to be looked at by the target person when the target person answers the question;
performing second processing of determining a direction being looked at by the target person by using the facial image; and
performing third processing of, by using a direction to be looked at by the target person when the target person answers the question and a direction determined to be looked at by the target person, authenticating the person.
   30. The authentication method according to 29., wherein
a standard answer to the question is preset for each of a plurality of persons, and
the authentication method further includes, by the one or more computers:
   in the first processing, causing the screen to display the question and also causes the screen to display the direction information, based on the standard answer; and
   in the third processing, determining validity of an answer to the question by the target person by using the standard answer for the target person and a direction determined to be looked at by the target person and performing authentication of the target person, based on the validity.
      31. The authentication method according to 30., further including, by the one or more computers,
in the third processing, determining the direction related to the standard answer for the target person as a standard direction and determining the validity of an answer to the question by the target person by using the determined standard direction and a direction determined to be looked at by the target person.
   32. The authentication method according to 31., further including, by the one or more computers,
in the third processing, determining an answer to the question, the answer being indicated by a direction determined to be looked at by the target person, and determining the validity of an answer to the question by the target person by using the determined answer and the standard answer for the target person.
   33. The authentication method according to any one of 30. to 32., further including, by the one or more computers,
accepting the standard answer for each of a plurality of persons and storing the standard answer into a storage unit in association with the person.
   34. The authentication method according to any one of 29. to 33., further including, by the one or more computers:
in the first processing,
   causing the screen to display a plurality of alternatives related to the question, and
   for each of the plurality of alternatives, causing the screen to display, as the direction information, the direction to be looked at by the target person when the target person selects the alternative; and
when performing the authentication, performing the third processing by using a direction to be looked at by the target person, the direction being related to an alternative indicating a correct answer to a question, and a direction determined to be looked at by a target person.
   35. The authentication method according to any one of 29. to 34., further including, by the one or more computers:
executing authentication processing using a facial image of the person; and
executing the first processing, the second processing, and the third processing at a predetermined timing after successful authentication of the target person.
   36. The authentication method according to 35., wherein
the predetermined timing is regularly or irregularly.
   37. The authentication method according to 35. or 36., wherein
the predetermined timing is when a facial image of the target person satisfies a predetermined criterion in the authentication processing.
   38 The authentication method according to any one of 35. to 37., further including, by the one or more computers:
executing authentication processing using a facial image of the target person at an initial login; and
executing the first processing, the second processing, and the third processing after successful authentication of the target person.
   39 The authentication method according to 37. or 38., wherein
the predetermined criterion includes a score indicating a result of the authentication processing using a facial image of the target person being equal to or less than a reference value.
   40. The authentication method according to any one of 37. to 39., further including, by the one or more computers,
detecting at least one of a predetermined part of a face and a predetermined wearing article from a facial image of the target person, wherein
the predetermined criterion includes, when the authentication processing is performed, at least one item out of inability to detect a predetermined part of a face of the target person and detection of the predetermined wearing article.
   41. The authentication method according to any one of 37. to 40., wherein
the predetermined criterion includes temporary inability to acquire a facial image of the target person.
   42. The authentication method according to any one of 39. to 41., further including, by the one or more computers,
acquiring a background image of a facial image of the target person and detecting a change in the background image, wherein
the predetermined criterion includes detection of a change in the background image.
   43. A program for causing one or more computers to execute:
a procedure for acquiring a facial image of a target person being a person to be a target of authentication;
a procedure for performing first processing of causing a screen that can be looked at by the target person to display a question and also causing the screen to display direction information indicating a direction to be looked at by the target person when the target person answers the question;
a procedure for performing second processing of determining a direction being looked at by the target person by using the facial image; and
a procedure for performing third processing of, by using a direction to be looked at by the target person when the target person answers the question and a direction determined to be looked at by the target person, authenticating the person.
   44. The program according to 43., wherein
a standard answer to the question is preset for each of a plurality of persons, and
the program further causes the computers to execute:
   a procedure for, in the first processing, causing the screen to display the question and also causing the screen to display the direction information, based on the standard answer; and
   a procedure for, in the third processing, determining validity of an answer to the question by the target person by using the standard answer for the target person and a direction determined to be looked at by the target person and performing authentication of the target person, based on the validity.
      45. The program according to 44., further causing the computers to execute
a procedure for, in the third processing, determining the direction related to the standard answer for the target person as a standard direction and determining the validity of an answer to the question by the target person by using the determined standard direction and a direction determined to be looked at by the target person.
   46. The program according to 44., further causing the computers to execute,
a procedure for, in the third processing, determining an answer to the question, the answer being indicated by a direction determined to be looked at by the target person, and determining the validity of an answer to the question by the target person by using the determined answer and the standard answer for the target person.
   47. The program according to any one of 44. to 46., further causing the computers to execute
a procedure for accepting the standard answer for each of a plurality of persons and storing the standard answer into a storage unit in association with the person.
   48. The program according to any one of 43. to 47., further causing the computers to execute:
a procedure for, in the first processing,
   causing the screen to display a plurality of alternatives related to the question, and
   for each of the plurality of alternatives, causing the screen to display, as the direction information, the direction to be looked at by the target person when the target person selects the alternative; and
a procedure for performing the third processing by using a direction to be looked at by the target person, the direction being related to an alternative indicating a correct answer to a question, and a direction determined to be looked at by a target person.
   49. The program according to any one of 43. to 48., further causing the computers to execute:
a procedure for executing authentication processing using a facial image of the person; and
a procedure for executing the first processing, the second processing, and the third processing at a predetermined timing after successful authentication of the target person.
   50 The program according to 49., wherein
the predetermined timing is regularly or irregularly.
   51. The program according to 49. or 50., wherein
the predetermined timing is when a facial image of the target person satisfies a predetermined criterion in the authentication processing.
   52. The program according to any one of 49. to 51., further causing the computers to execute:
a procedure for executing authentication processing using a facial image of the target person at an initial login; and
a procedure for executing the first processing, the second processing, and the third processing after successful authentication of the target person.
   53. The program according to 51. or 52., wherein
the predetermined criterion includes a score indicating a result of the authentication processing using a facial image of the target person being equal to or less than a reference value.
   54. The program according to any one of 51. to 53., further causing the computers to execute
a procedure for detecting at least one of a predetermined part of a face and a predetermined wearing article from a facial image of the target person, wherein
the predetermined criterion includes, when the authentication processing is performed, at least one item out of inability to detect a predetermined part of a face of the target person and detection of the predetermined wearing article.
   55. The program according to any one of 51. to 54., wherein
the predetermined criterion includes temporary inability to acquire a facial image of the target person.
   56. The program according to any one of 53. to 55., further causing the computers to execute
a procedure for acquiring a background image of a facial image of the target person and detecting a change in the background image, wherein
the predetermined criterion includes detection of a change in the background image.

### REFERENCE SIGNS LIST

1 Authentication system
3 Communication network
20 Operation terminal
30 Display apparatus
40 Camera
100 Authentication apparatus
102 Acquisition unit
104 Display processing unit
106 Determination unit
108 Authentication unit
110 Acceptance unit
112 Detection unit
120 Storage apparatus
140 Question information
200 Screen
210 Message display part
220a, 220b Mark display part
230 Region
250 Facial image
300 Registration screen
310 List display part
320 Entry field
330 Icon
340 Registration button
350 Cancel button
1000 Computer
1010 Bus
1020 Processor
1030 Memory
1040 Storage device
1050 Input-output interface
1060 Network interface

What is claimed is:

1. An authentication apparatus comprising:
at least one memory storing instructions; and
at least one processor configured to execute the instructions to:
acquire a facial image of a target person being a person to be a target of authentication;
perform first processing of causing a screen that can be looked at by the target person to display a question and also causing the screen to display direction information indicating a direction to be looked at by the target person when the target person answers the question;
perform second processing of determining a direction being looked at by the target person by using the facial image; and
perform third processing of, by using a direction to be looked at by the target person when the target person answers the question and the direction determined to be looked at by the target person, authenticating the person.

2. The authentication apparatus according to claim 1, wherein
a standard answer to the question is preset for each of a plurality of persons, and
the at least one processor is further configured to execute the instructions to:
in the first processing, cause the screen to display the question and also cause the screen to display the direction information, based on the standard answer; and
in the third processing, determine validity of an answer to the question by the target person by using the standard answer for the target person and a direction determined to be looked at by the target person and perform authentication of the target person, based on the validity.

3. The authentication apparatus according to claim 2, wherein,
the at least one processor is further configured to execute the instructions to
in the third processing, determine the direction related to the standard answer for the target person as a standard direction and determine the validity of an answer to the question by the target person by using the determined standard direction and a direction determined to be looked at by the target person.

4. The authentication apparatus according to claim 2, wherein
the at least one processor is further configured to execute the instructions to
in the third processing, determine an answer to the question, the answer being indicated by a direction determined to be looked at by the target person, and determine the validity of an answer to the question by the target person by using the determined answer and the standard answer for the target person.

5. The authentication apparatus according to claim 2, wherein the at least one processor is further configured to execute the instructions to
accept the standard answer for each of a plurality of persons and store the standard answer into a storage unit in association with the person.

6. The authentication apparatus according to claim 1, wherein
the at least one processor is further configured to execute the instructions to:
in the first processing,
cause the screen to display a plurality of alternatives related to the question, and
for each of the plurality of alternatives, cause the screen to display, as the direction information, the direction to be looked at by the target person when the target person selects the alternative, and
perform the third processing by using a direction to be looked at by the target person, the direction being related to an alternative indicating a correct answer to a question, and a direction determined to be looked at by a target person.

7. The authentication apparatus according to claim 1, wherein
the at least one processor is further configured to execute the instructions to:
execute authentication processing using a facial image of the person; and
respectively execute the first processing, the second processing, and the third processing at a predetermined timing after successful authentication of the target person.

8. The authentication apparatus according to claim 7, wherein
the predetermined timing is regularly or irregularly.

9. The authentication apparatus according to claim 7, wherein
the predetermined timing is when a facial image of the target person satisfies a predetermined criterion in the authentication processing.

10. The authentication apparatus according to claim 7, wherein
the at least one processor is further configured to execute the instructions to:
execute authentication processing using a facial image of the target person at an initial login; and
respectively execute the first processing, the second processing, and the third processing after successful authentication of the target person.

11. The authentication apparatus according to claim 9, wherein
the predetermined criterion includes a score indicating a result of the authentication processing using a facial image of the target person being equal to or less than a reference value.

12. The authentication apparatus according to claim 9, wherein the at least one processor is further configured to execute the instructions to
detect at least one of a predetermined part of a face and a predetermined wearing article from a facial image of the target person, wherein
the predetermined criterion includes, when the authentication processing is performed, at least one item out of inability to detect a predetermined part of a face of the target person and detection of the predetermined wearing article.

13. The authentication apparatus according to claim 9, wherein
the predetermined criterion includes temporary inability to acquire a facial image of the target person.

14. The authentication apparatus according to claim 11, wherein the at least one processor is further configured to execute the instructions to
acquire a background image of a facial image of the target person and detect a change in the background image, and
the predetermined criterion includes detection of a change in the background image.

15. An authentication system comprising:
an information processing apparatus; and
an authentication apparatus according to claim 1, connected to the information processing apparatus through a network, wherein
the information processing apparatus includes:
a display unit that displays a screen that can be looked at by a person to be a target of authentication; and
an image capture unit that generates a facial image of the person looking at the screen, and
the authentication apparatus includes:
at least one memory storing instructions; and
at least one processor configured to execute the instructions to:
acquire a facial image of a target person being a person to be a target of authentication;
perform first processing of causing a screen that can be looked at by the target person to display a question and also causing the screen to display direction information indicating a direction to be looked at by the target person when the target person answers the question;
perform second processing of determining a direction being looked at by the target person by using the facial image; and
perform third processing of, by using a direction to be looked at by the target person when the target person answers the question and a direction determined to be looked at by the target person, authenticating the person.

16. An authentication method comprising, by one or more computers:
acquiring a facial image of a target person being a person to be a target of authentication;
performing first processing of causing a screen that can be looked at by the target person to display a question and also causing the screen to display direction information indicating a direction to be looked at by the target person when the target person answers the question;
performing second processing of determining a direction being looked at by the target person by using the facial image; and
performing third processing of, by using a direction to be looked at by the target person when the target person answers the question and a direction determined to be looked at by the target person, authenticating the person.

17. A non-transitory computer-readable storage medium storing a program for causing a computer to execute:
a procedure for acquiring a facial image of a target person being a person to be a target of authentication;
a procedure for performing first processing of causing a screen that can be looked at by the target person to display a question and also causing the screen to display direction information indicating a direction to be looked at by the target person when the target person answers the question;
a procedure for performing second processing of determining a direction being looked at by the target person by using the facial image; and
a procedure for performing third processing of, by using a direction to be looked at by the target person when the target person answers the question and a direction determined to be looked at by the target person, authenticating the person.
